(19) United States
(12) Patent Application Publication
(10) Pub. No.: US 2015/0161733 A1
(43) Pub. Date: Jun. 11, 2015

(54) Life Cycle Based Portfolio Construction Platform Apparatuses, Methods and Systems

(71) Applicant: FMR LLC, Boston, MA (US)

(72) Inventors: Lisa Jane Emsbo-Mattingly, Lexington, MA (US); Hongshu Chen, Newton, MA (US); Emil Petrov Iantchev, Cambridge, MA (US)

(21) Appl. No.: 14/494,443

(22) Filed: Sep. 23, 2014

Related U.S. Application Data
(60) Provisional application No. 61/882,185, filed on Sep. 25, 2013.

(51) Int. Cl. G06Q 40/06

(52) U.S. Cl. CPC G06Q 40/06

(57) ABSTRACT

The Life Cycle Based Portfolio Construction Platform Apparatuses, Methods and Systems (“LPC”) transforms LPC Server data request (e.g., see 201 in FIG. 2, etc.) inputs via LPC components into sector-based portfolio investment transaction records outputs. In various implementations, the LPC receives historical investment data indicating investment returns from a data provider, generates a risk boundary curve for equity allocation at different investor age segments based on the received historical investment data, receives a portfolio construction request, and generates a life cycle based portfolio based on the retrieved equity allocation boundary value. The risk boundary curve may include a piecewise linear line, be generated via backward induction from a senior age segment to a junior age segment, and/or be determined based on an optimal average discounted utility over a set of adverse scenarios calculated based on different equity allocation percentages.

### PRIORITY CLAIM

Applicant hereby claims benefit to priority under 35 USC 5119 as a non-provisional conversion U.S. provisional patent application Ser. No. 61/882,185, filed 25 Sep. 2013, entitled “LIFE CYCLE BASED PORTFOLIO CONSTRUCTION PLATFORM APPARATUSES, METHODS AND SYSTEMS,” (attorney docket no. FIDE-004/00US).

The entire contents of the aforementioned applications are herein expressly incorporated by reference.

This application for letters patent disclosure document describes inventive aspects that include various novel innovations (hereinafter “disclosure”) and contains material that is subject to copyright, mask work, and/or other intellectual property protection. The respective owners of such intellectual property have no objection to the facsimile reproduction of the disclosure by anyone as it appears in published Patent Office file/records, but otherwise reserve all rights.

### FIELD

The present innovations generally address portfolio information technologies construction, and more particularly, include Life Cycle Based Portfolio Construction Platform Apparatuses, Methods and Systems.

However, in order to develop a reader's understanding of the innovations, disclosures have been compiled into a single description to illustrate and clarify how aspects of these innovations operate independently, interoperate as between individual innovations, and/or cooperate collectively. The application goes on to further describe the interrelations and synergies as between the various innovations; all of which is to further compliance with 35 U.S.C. §112.

### BACKGROUND

Consumers invest in financial instruments to pursue an economic profit. Consumers buy publicly traded financial instruments from a public trading exchange platform (i.e., an outcry bidding system). Common publicly traded financial instruments are stocks, bonds, future contracts, and options. Consumers can buy or sell one or more types of financial instruments to form an investment portfolio. In order to manage the performance of the investment portfolio, consumers need to closely track the pricing index of each financial instrument in the portfolio on a daily basis.

### BRIEF DESCRIPTION OF THE DRAWINGS

Appendices and/or drawings illustrating various, non-limiting, example, innovative aspects of the Life Cycle Based Portfolio Construction Platform Apparatuses, Methods and Systems (hereinafter “LPC”) disclosure, include:

The accompanying appendices, drawings, figures, images, etc. illustrate various example, non-limiting, inventive aspects, embodiments, and features (“e.g.,” or “example(s)”) in accordance with the present disclosure:

FIG. 1 provides an example diagram illustrating aspects of life cycle based risk boundary portfolio construction within embodiments of the LPC;

FIG. 2 provides an example datagraph diagram illustrating aspects of interactive data flows between the LPC server and its affiliated entities for life cycle based portfolio construction within embodiments of the LPC;

FIGS. 3A-3B provide example logic flow diagrams illustrating aspects of work flows for risk boundary generation and life cycle based portfolio construction within embodiments of the LPC;

FIG. 4A provide an example user interface (UI) illustrating user customization parameters within embodiments of the LPC;

FIGS. 4B-4F provide exemplary data formats and code segments for risk boundary generation within embodiments of the LPC;

FIGS. 5A-5G provide exemplary data charts illustrating risk boundary generation within embodiments of the LPC;

FIGS. 6A-6F provide additional exemplary data charts illustrating risk boundary generation within embodiments of the LPC; and

FIG. 7 shows a block diagram illustrating embodiments of an LPC controller;

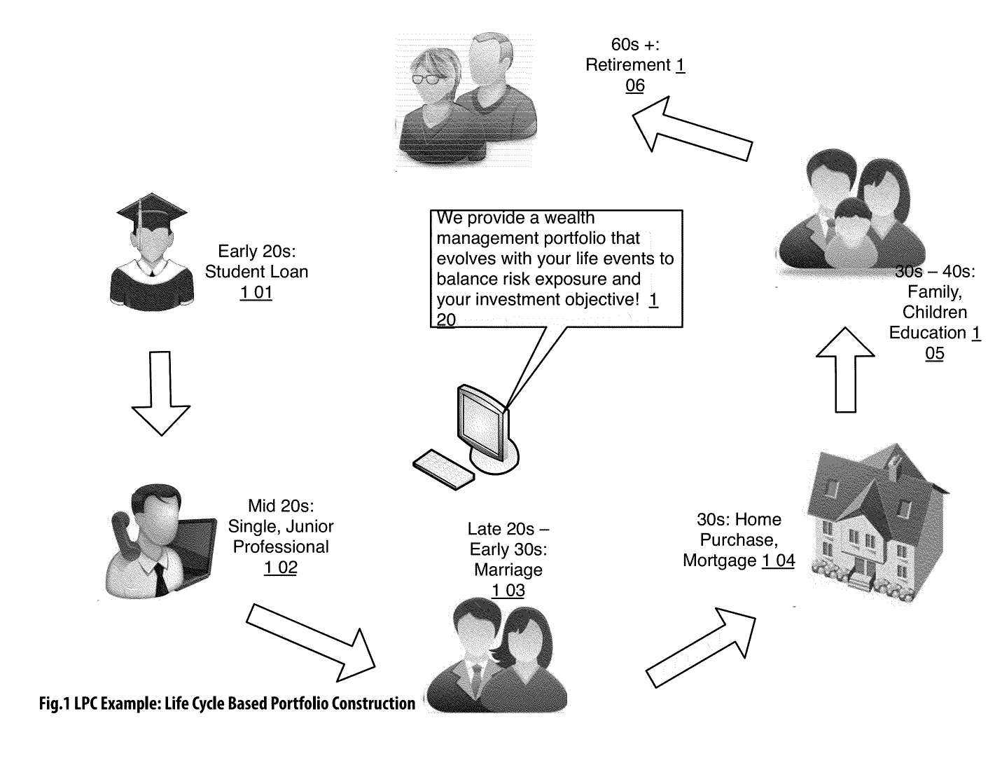

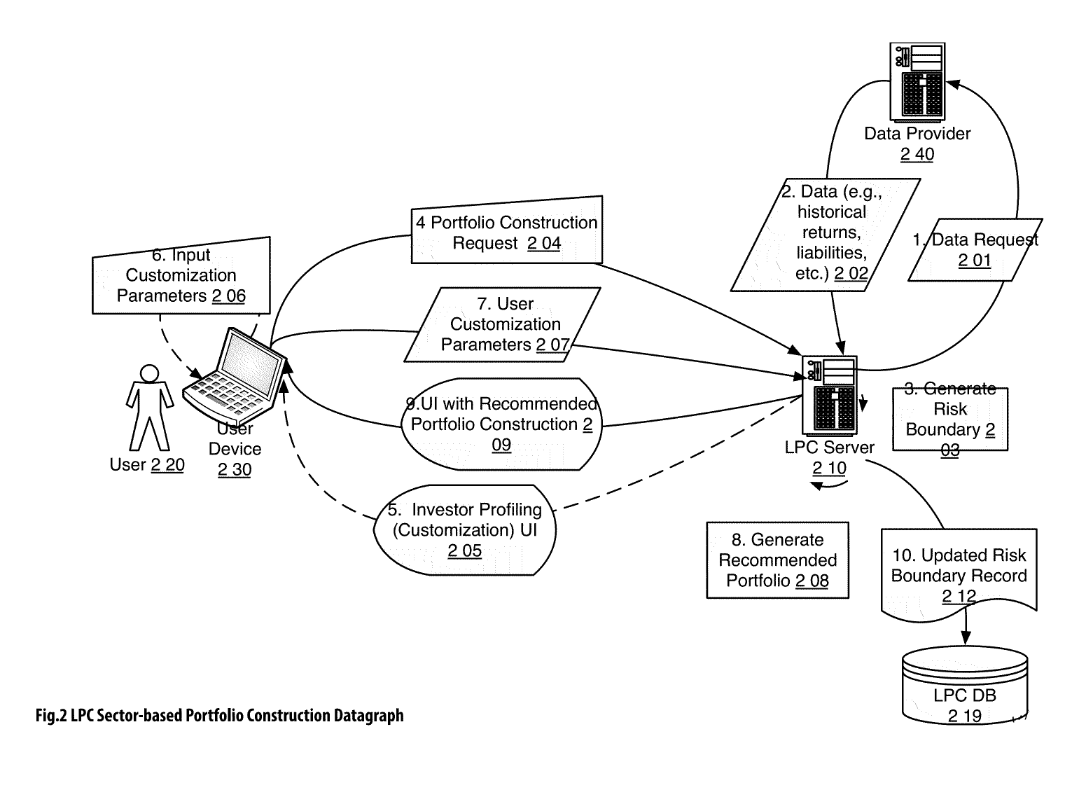

Generally, the leading number of each citation number within the drawings indicates the figure in which that citation number is introduced and/or detailed. As such, a detailed discussion of citation number 101 would be found and/or introduced in FIG. 1. Citation number 201 is introduced in FIG. 2, etc. Any citation and/or reference numbers are not necessarily sequences but rather just example orders that may be rearranged and other orders are contemplated.

### DETAILED DESCRIPTION

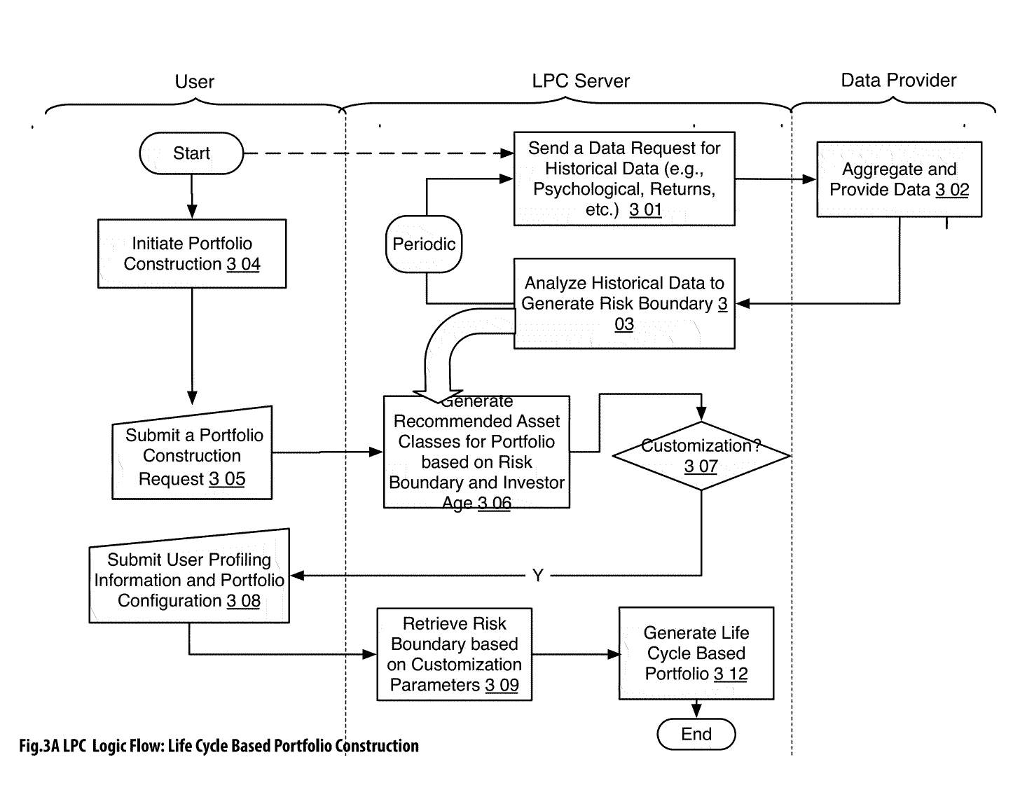

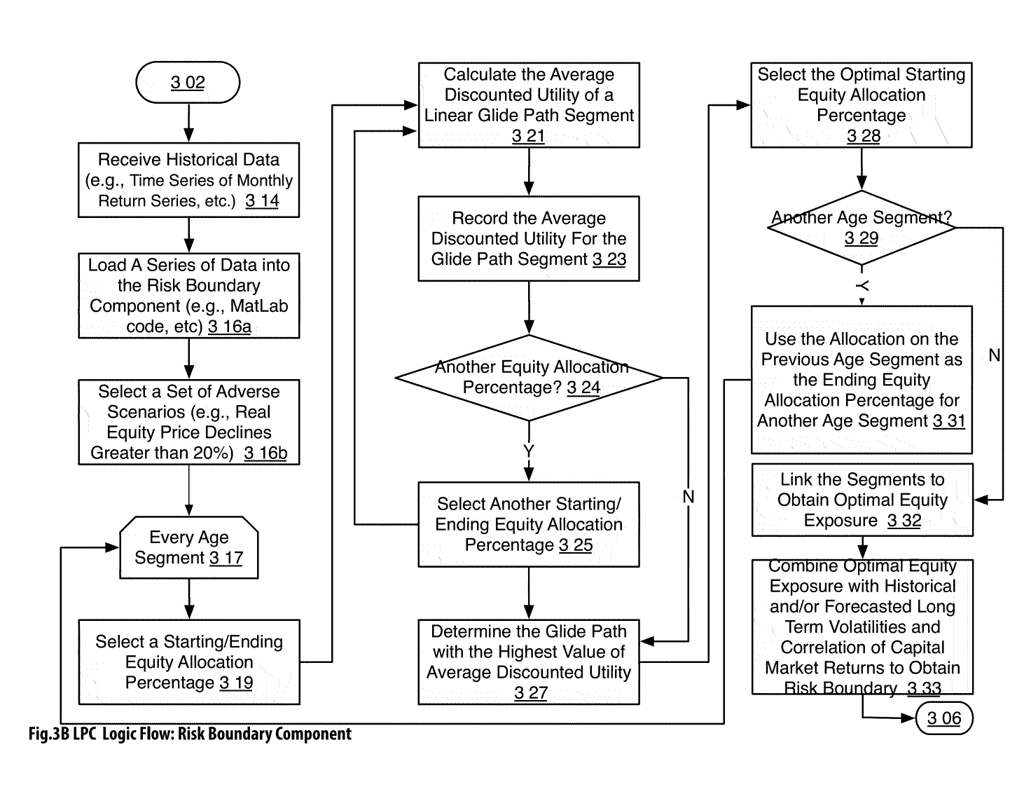

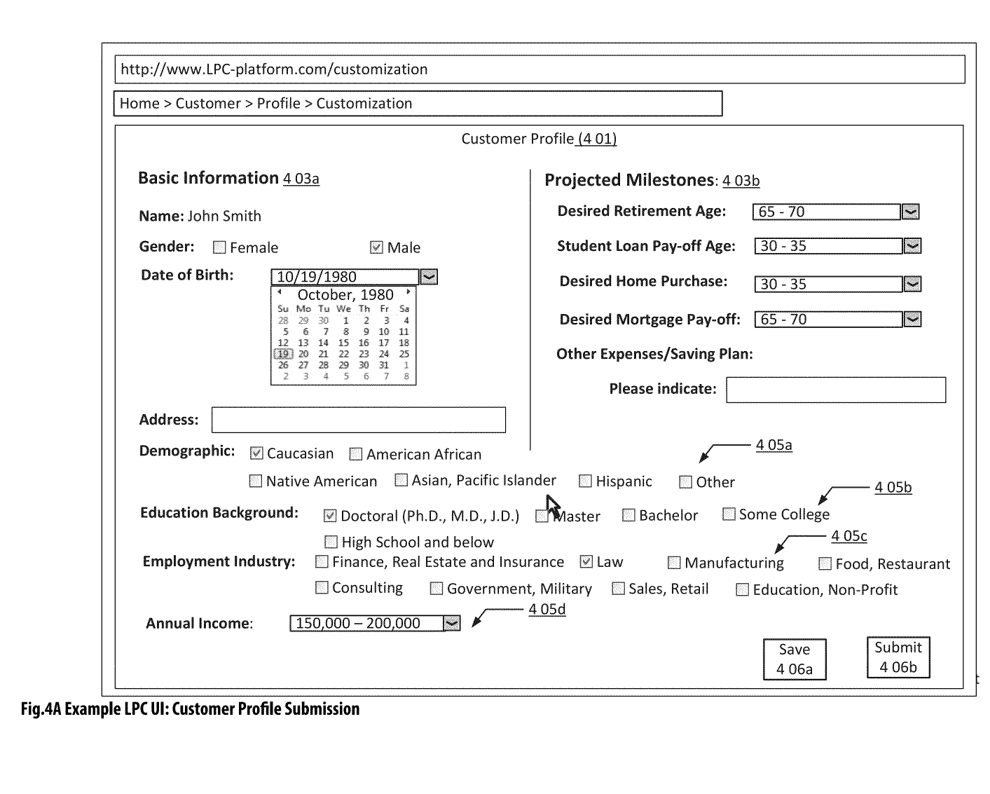

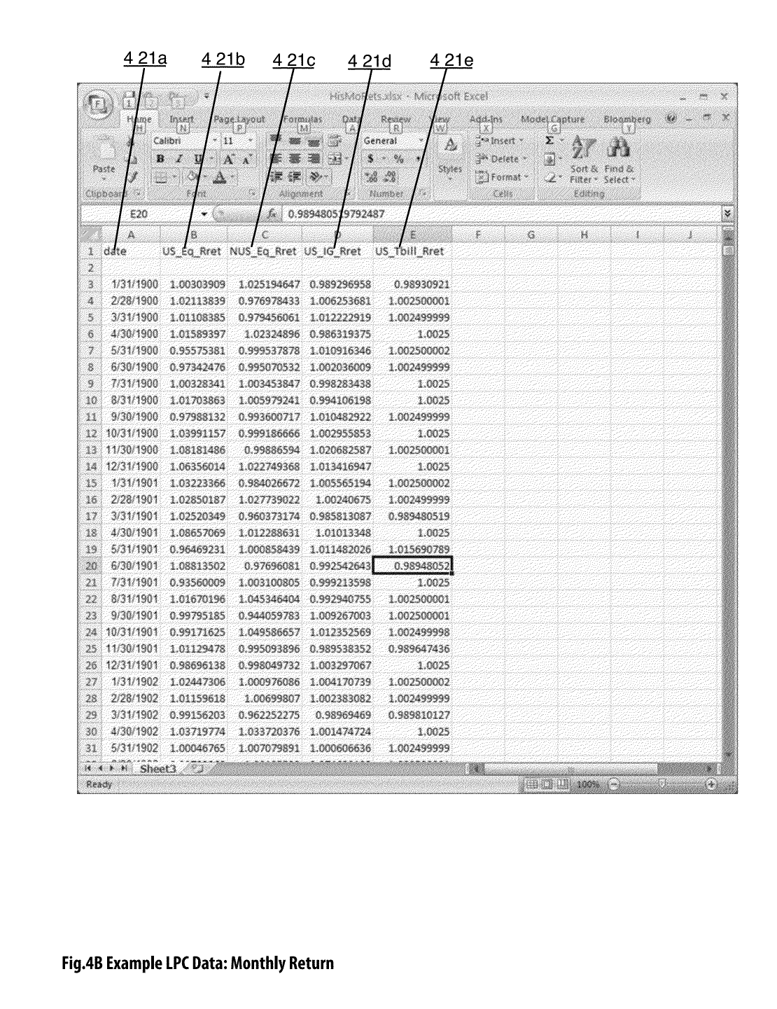

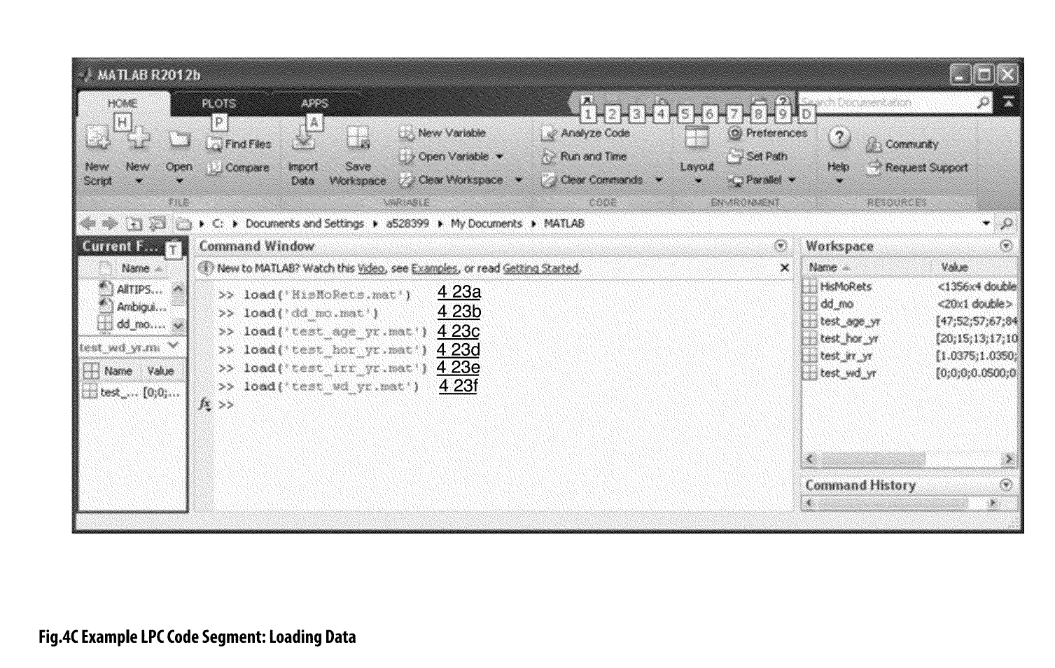

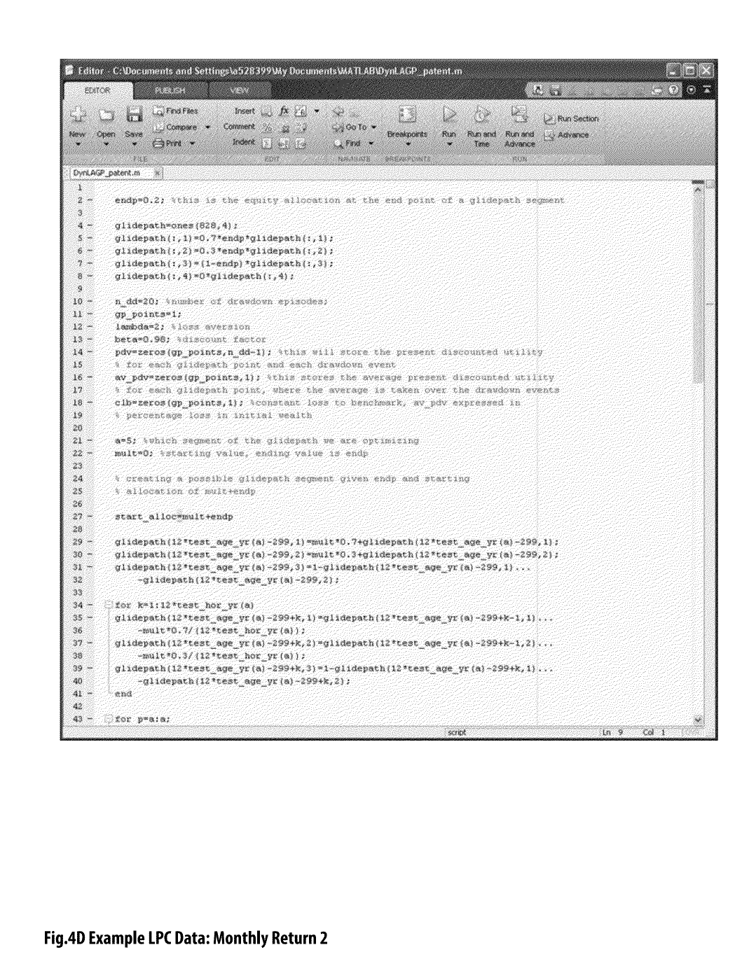

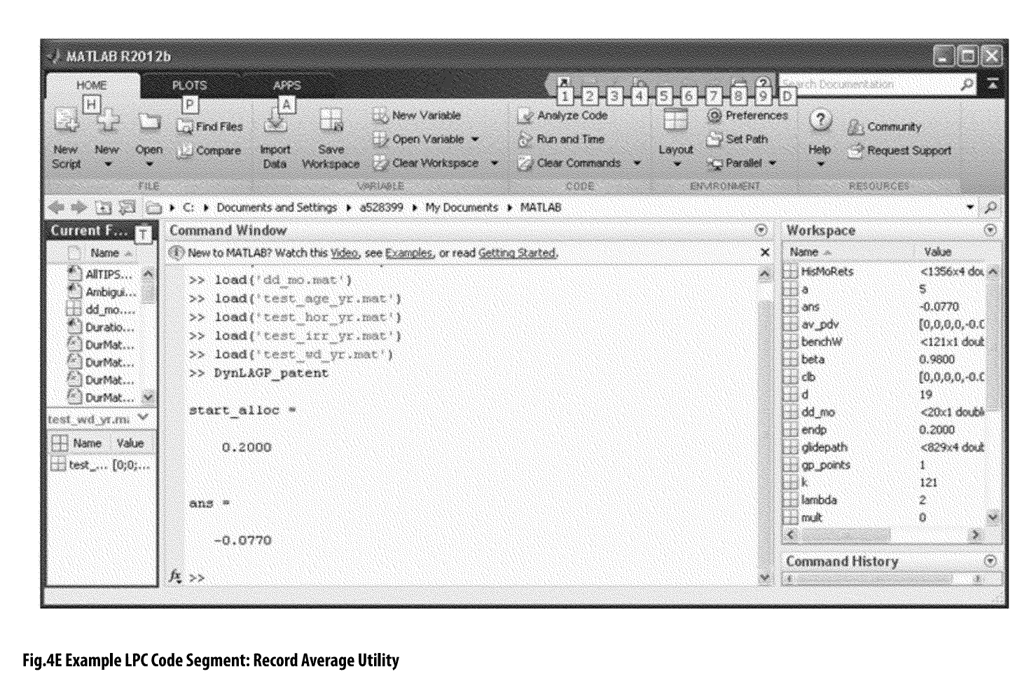

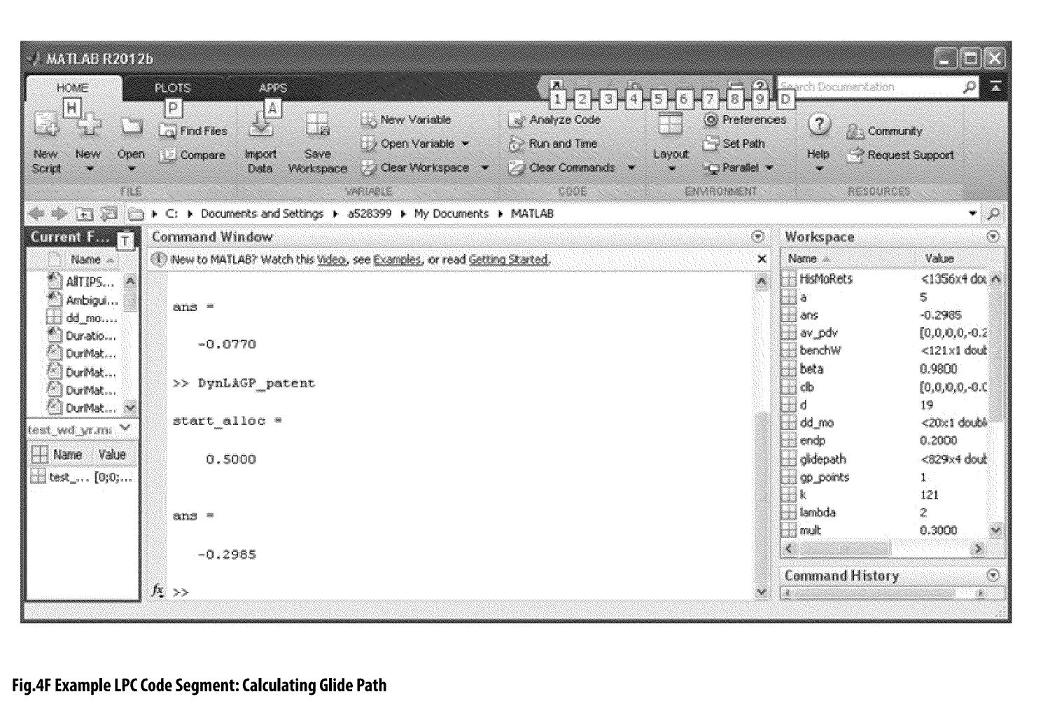

The Life Cycle Based Portfolio Construction Platform Apparatuses, Methods and Systems (hereinafter “LPC”) transforms LPC Server data request (e.g., see 201 in FIG. 2, etc.) inputs, via LPC components (e.g., historical data collector 742 (e.g., see FIG. 4B, etc.), risk boundary generation 743 (e.g., see FIGS. 3B, 5D-5E and 6C-6E, etc.), user customization analytics 744 (e.g., see FIG. 4A, etc.), portfolio construction 745 (e.g., see FIG. 3A, etc.), etc., into sector-based portfolio investment transaction records outputs. The LPC components, in various embodiments, implement advantageous features as set forth below.

### INTRODUCTION

The provides an investment analytics and management tool facilitating a user (e.g., investors, consumers, portfolio managers, traders, etc.) to research, build and maintain an investment portfolio that evolves with time and reflects different objectives at different stages of an individual life cycle. In one implementation, the LPC may employ a combination of various models, such as but not limited to a prospect theory model, a robust control model and/or the like, to create a risk capacity glidepath constraint (risk boundary) that balances the accomplishment of a reasonable investment and retirement objective for clients while minimizing their exposure to drawdown risks and return forecast errors.

For example, in one implementation, an individual investor may have different tolerance levels towards risk exposure at different stages in life, e.g., higher tolerance to risk exposure at an earlier stage when the individual is most likely to be younger and single, lower tolerance to risk exposure at a later stage when the individual is most likely to approach the age of retirement, and/or the like. In one implementation, a variety of life events, such as but not limited to graduation, employment/unemployment, job changing, marital status change, child birth, child education, retirement, disease, and/or the like, may impact the individual investor's tolerance level to risk exposure and thus may impact the decision making in investment portfolio construction and/or execution.

In one implementation, LPC may establish a life-cycle based framework, e.g., a risk boundary that defines the maximum expected risk or volatility of a portfolio throughout the life cycle at different ages given historical and/or forecasted long term volatilities and correlations of capital market returns, etc. In one implementation, the LPC employ a glide path for the target date portfolios that focused on accumulating assets, which may combine capital market assumptions, participant behavior analytics, risk capacity, and/or the like to provide inflation-adjusted income for shareholders equal to approximately half of an investor's final preretirement salary during retirement.

### LPC

FIG. 1 provides an example diagram illustrating aspects of life cycle based risk boundary portfolio construction within embodiments of the LPC. For example, in one implementation, individual investors may experience different stages of life and may appear to have different tolerance levels towards investment risk due to the financial situation. For example, during one's early 20s, the individual may have student loan 101 and relatively low asset 101; at mid 20s, the individual may likely be a single junior professional 102 and thus may be willing to invest in high-risk instruments; at late 20s to early 30s, the individual may get married 103 and may move on with home purchase during 30s 104, who may likely incline to a more conservative investment portfolio; during 30s and 40s, the individual family may have family expenses and children education expenses 105, and thus the individual may have different investment portfolios that have a target date for, e.g., children's college plan, etc. In one implementation, when the individual approaches his retirement age, e.g., most likely during 60s, etc., the individual capacity to bear risk may decline.

In one implementation, the LPC may study the individual's risk exposure tolerance during life cycle and determine an investment allocation model that evolves with the life cycle stages 120. For example, when the individual has a higher risk tolerance, LPC may allocate a higher percentage of equity in the individual's investment portfolio; when the individual tends to be risk-averse, the LPC may allocate a lower percentage of equity in the individual's investment portfolio, and/or the like. As further discussed in FIGS. 3A-3B, the LPC may determine a risk boundary, e.g., a curve indicating the maximum expected risk or volatility of a portfolio through out the life cycle at different ages, etc., for portfolio construction.

FIG. 2 provides an example datagraph diagrams illustrating aspects of interactive data flows between the LPC server and its affiliated entities for life cycle based portfolio construction within embodiments of the LPC. Within embodiments, a LPC server 210, a user 220 (e.g., a consumer, an individual investor, a portfolio manager, a broker, etc.), a user device 230, a data provider 240 (e.g., stock exchange, standard index listing publishers, etc.), a LPC database 219, and/or the like, may interact and exchange data messages via a communication network with regard to risk boundary generation and life cycle based portfolio construction, monitoring, and execution within embodiments of the LPC.

In one embodiment, the LPC server 210 may constantly, intermittently, periodically, and/or on an on-demand basis, requesting data from a data provider 240. For example, the LPC server 210 may send a data request 201 to the Data provider 240, and obtain the data listing 202 (e.g., historical returns, psychological data towards risk, etc.). For example, in one implementation, the returned data 202 may include a variety of different data formats, including, but not limited to xml, csv, excel, txt, and/or the like. An exemplary data listing record 202 in the format of Excel spreadsheet is provided in FIG. 4B.

In one implementation, upon obtaining historical return data associated with various investors, the LPC may generate a risk boundary 203, e.g., a curve indicating the maximum expected risk or volatility of a portfolio of the portfolio through out the life cycle at different ages, etc., for portfolio construction. Further discussion and examples on risk boundary generation is provided in FIGS. 3B, 5D-5E and 6C-6E.

In one embodiment, a user 220 may operate a user device 230, which may include any of a desktop computer, a laptop computer, a tablet computer, a Smartphone (e.g., a BlackBerry, an Apple iPhone, a Google Android, a HTC, a Samsung Galaxy, etc.), and/or the like. In one implementation, the user device 230 may send a portfolio construction request 204 to the LPC server 210, wherein the portfolio construction request may indicate an investor's basic information (e.g., name, age, address, date of birth, gender, etc.). For example, the user device 230 may generate a (Secure) Hypertext Transfer Protocol (“HTTP(S)”) message including a portfolio construction request 204 in the form of data formatted according to the eXtensible Markup Language (XML). An example listing of a portfolio construction request 204, substantially in the form of a HTTP(S) message including XML-formatted data, is provided below:

```
POST /portfolio_request.php HTTP/1.1
Host: 192.168.23.126
Content-Type: Application/XML
Content-Length: 867
<?XML version = “1.0” encoding = “UTF-8”?>
<portfolio_request>
  <session_id> HUUUSDWE </session_id>
  <timestamp> 2014-02-22 15:22:43</timestamp>
  <user_id> JS001 </user_id>
  <client_details>
      <client_IP>192.168.23.126</client_IP>
      <client_type>smartphone</client_type>
      <client_model>HTC Hero</client_model>
      <device_id> HTC_JS_001 </device_id>
      ...
  <client_details>
  <user>
      <name> John Smith </name>
      <DOB> 1980-10-21 </DOB>
      <gender> m </gender>
      <address>
          <street> 111 Palm Street </street>
          <city> Palm Beach </city>
          <state> CA </state>
          <zipcode> 00000 </zipcode>
          ...
      </address>
      ...
<request>
    <target> retirement </target>
    <target_age> 65 </target_age>
    <current_age>35</current_age>
    <loss_aversion>2.5</loss_aversion>
    ...
  </request>
...
<portfolio_request>
```

In one implementation, as further discussed in FIG. 3A (e.g., 307, etc.), the LPC server 210 may optionally return a UI for investor profiling (customization) 205, e.g., see FIG. 4A. For example, in one implementation, the user may then input customization parameters 206, and submit the user customization parameters via the user interface to the LPC 210.

For example, the user device 230 may generate a HTTP(S) message including user customization parameters 207 in the form of data formatted according to the XML. An example listing of the user customization parameters 207, substantially in the form of a HTTP(S) POST message including XML-formatted data, is provided below:

```
POST /user_customization.php HTTP/1.1
Host: 192.168.23.126
Content-Type: Application/XML
Content-Length: 867
<?XML version = “1.0” encoding = “UTF-8”?>
<user_customization>
  <session_id> HUUUSDWE </session_id>
  <timestamp> 2014-02-22 15:22:46</timestamp>
  <user_id> JS001 </user_id>
  <client_details>
      <client_IP>192.168.23.126</client_IP>
      <client_type>smartphone</client_type>
      <client_model>HTC Hero</client_model>
      <device_id> HTC_JS_001 </device_id>
      ...
  <client_details>
  <basic_info>
      <name> John Smith </name>
      <DOB> 1980-10-21 </DOB>
      <gender> m </gender>
      <address>
          <street> 111 Palm Street </street>
          <city> Palm Beach </city>
          <state> CA </state>
          <zipcode> 00000 </zipcode>
          ...
      </address>
      <demo> Caucasian </demo>
      ...
  <basic_info>
  <education> doctoral </education>
  <employment_industry> law </employment_industry>
  <annual_income>
      <low> 150,000 </low>
      <high> 200,000 </high>
      ...
  </annual_income>
  <projected_milestone>
      <retirement_age> 65 - 70 </retirement_age>
      <percentage_final_salary> 60% </percentage_final_salary>
      <loss_aversion> 2.5 </loss_aversion>
      <student_load_pay-off> 30-35 </student_loan_pay-off>
      <home_purchase> 30-35 </home_purchase>
      <mortgage_pay-off> 65-70 </mortgage_pay-off>
      ...
  </projected_milestone>
  ...
</user_customization >
```

In one implementation, the LPC server 220 may generate an investment portfolio 208, e.g., based on an equity allocation percentage defined in the risk boundary, etc.

In one implementation, the LPC server may provide a list of recommended portfolio construction financial instrument to the user device 230, and may store the updated risk boundary 212 at the LPC database 219. An exemplary listing, written substantially in the form of PHP/SQL commands, to store the transaction record data 235 to the LPC database, is provided below:

<?PHP
header(‘Content-Type: text/plain’);
...
// store input data in a database
mysql_connect(“201.408.185.132”,$LPC_server,$password); // access
database server
mysql_select(“LPC_DB.SQL”); // select database to append
mysql_query(“INSERT INTO RiskBoundaryTable (timestamp,
age_sub_list,
equity_allocation_list, user_employment, user_gender,
user_dob, user_education, user_industry,
user_retirement_age, ...)
VALUES ($timestamp, $age_sub_list, $equity_allocation_list,
$user_employment, $user_gender, $user_dob, $user_education,
$user_industry,
$user_retirement_age, ...); // add data to RiskBoundaryTable table in a
CLIENT database
mysql_close(“LPC_DB.SQL”); // close connection to database
?>

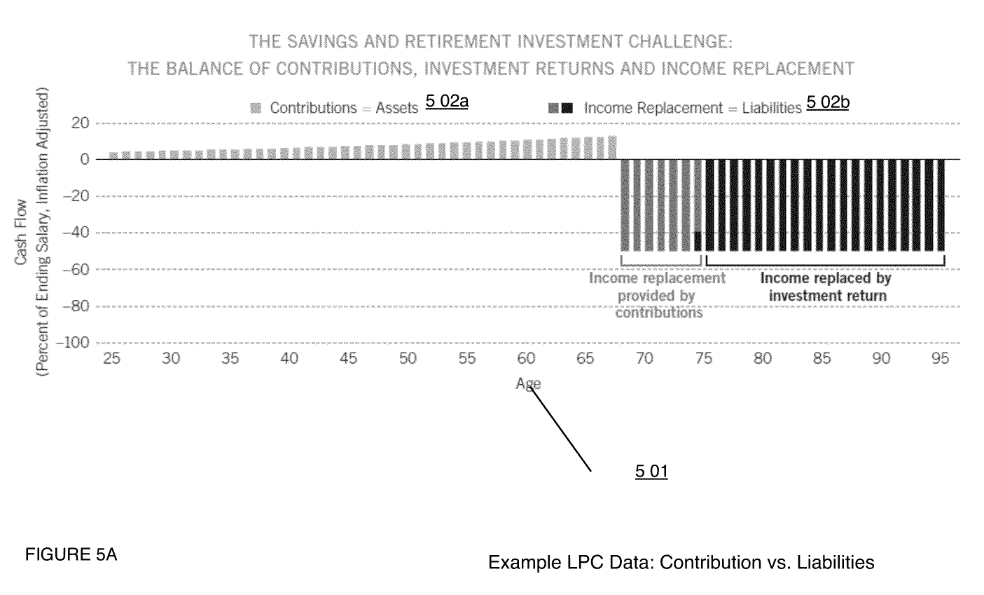

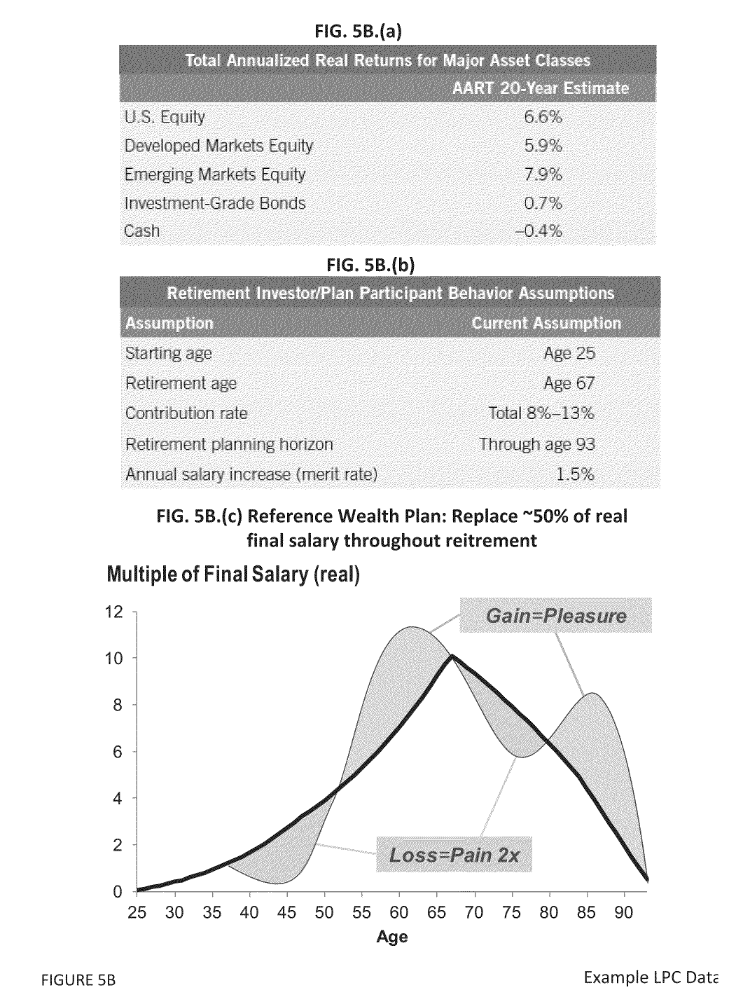

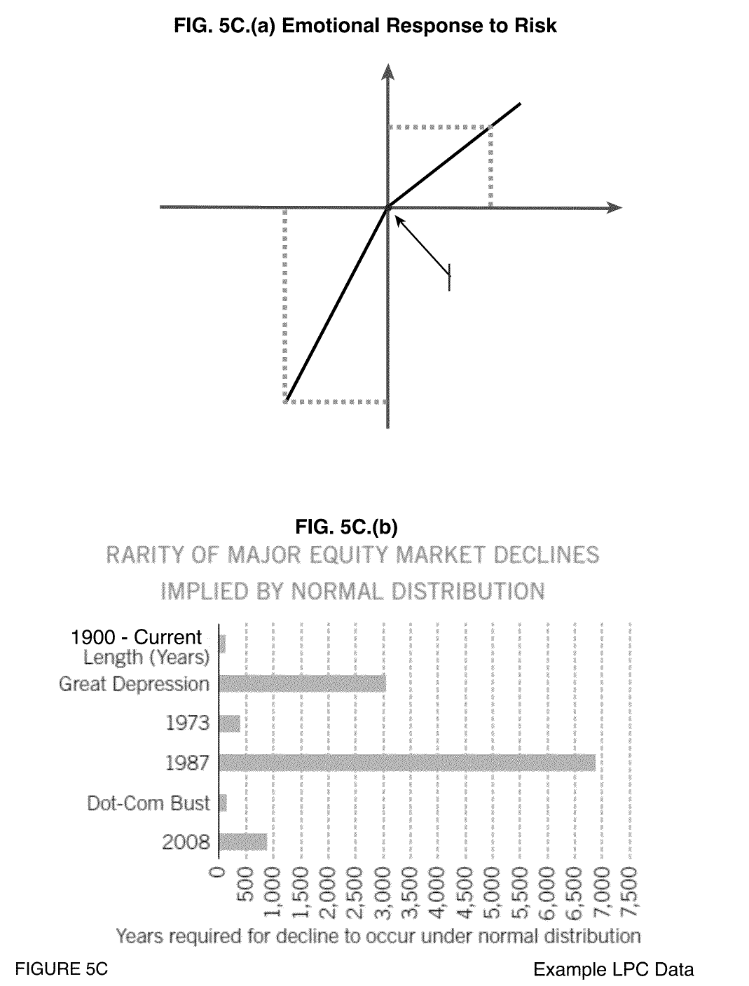

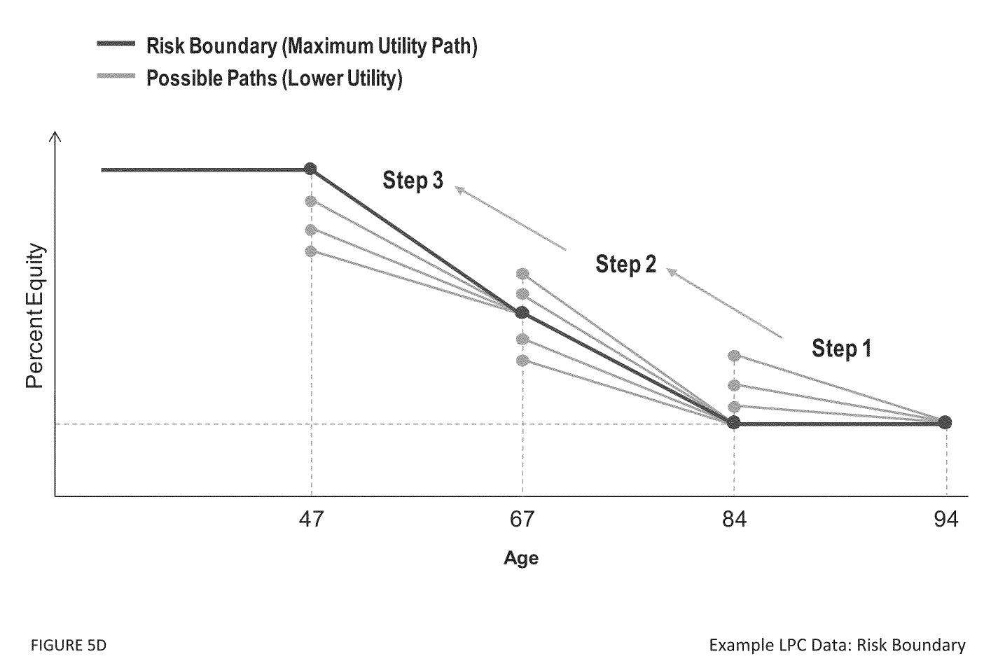

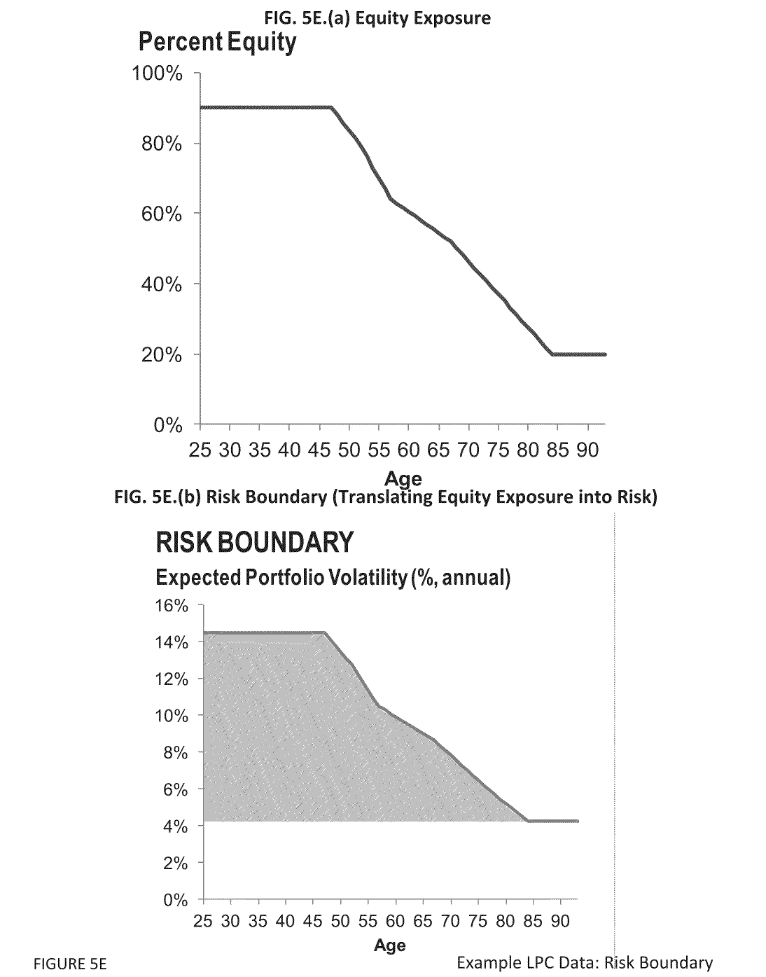

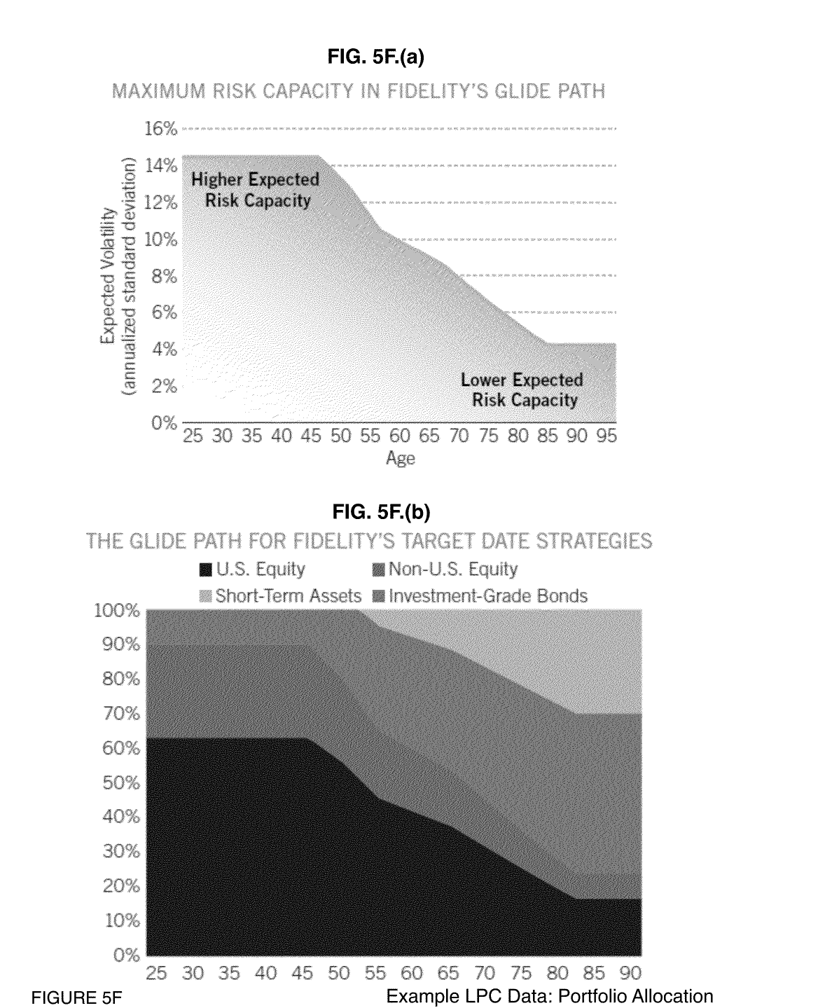

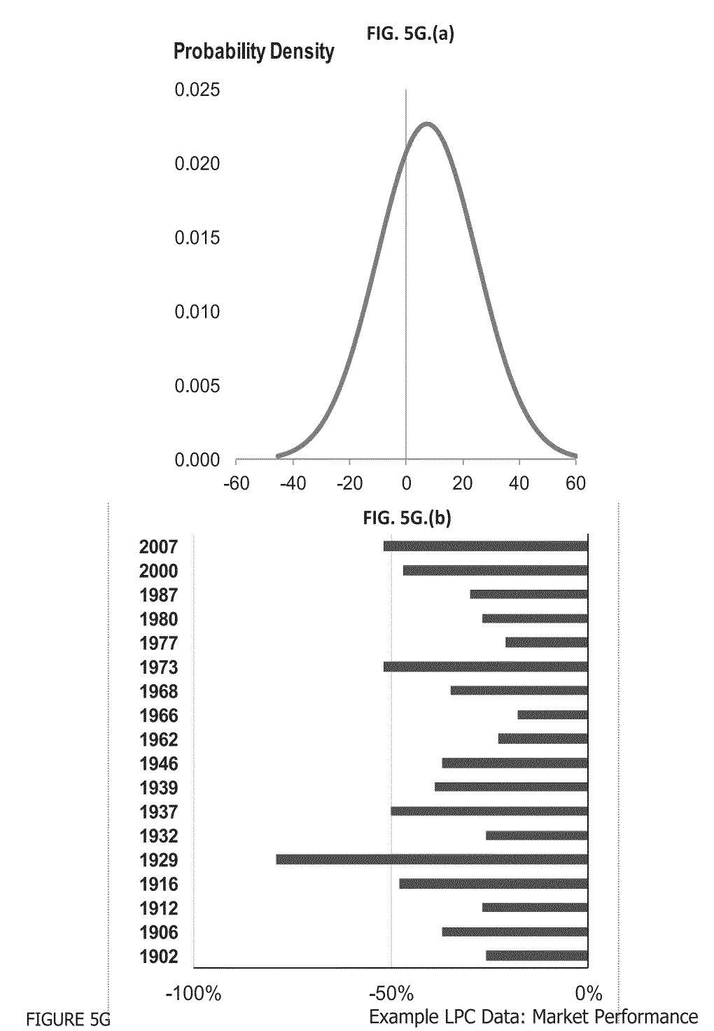

FIGS. 3A-3B provide example logic flow diagrams illustrating aspects of work flows for life cycle based portfolio construction including risk boundary generation within embodiments of the LPC. With reference to FIG. 3A, the LPC server may obtain data (e.g., historical data reflecting investment returns, etc.) from a data provider constantly, periodically, intermittently, and/or on demand. For example, in one implementation, the LPC server may send a data request for the historical investment returns (e.g., 421a-e in FIG. 4B, etc.) 301 to a data provider (e.g., McGraw-Hill, Russell Investment, Standard & Poor's, Bloomberg, etc.), which may aggregate and provide such historical investment return data 302. Upon receiving the historical investment data, the LPC may analyze such historical data to generate a risk boundary. For example, the risk boundary may comprise a set of equity allocation percentage at different ages, e.g., at the age 25, 35, 45, 55, and/or the like, and a linear connection linking the different equity allocation percentage points, which are then translated into expected portfolio risk or volatility given historical and/or forecasted long term volatilities and correlations of capital market returns e.g., see FIG. 5D. Further aspects of the component 303 are discussed in FIG. 3B.

Within implementations, a user (e.g., an investor, a portfolio manager, a broker, a consumer, etc.) may initiate a portfolio construction 304, e.g., by accessing a LPC web-based and/or mobile UI for portfolio construction, and submit a portfolio construction request (e.g., see data message 204 in FIG. 2).

In one implementation, the LPC server may generate recommended asset classes based on the risk boundary and user age group, and/or the like 306, e.g., a maximum 40% equity for the portfolio if the risk boundary at the user's age indicates 40%. In one implementation, the risk boundary may be a general model that fits for all investors. In another implementation, the risk boundary may comprises different boundaries categorized by a plurality of individual customization parameters, such as but not limited to investor demographics, investor geographic area, investor education, individual income, investor industry, and/or the like. For example, in one implementation, an individual working in the oil industry may have different job security from an individual working in the finance industry, and may have different risk tolerance for their retirement fund.

In one implementation, when such customized risk boundary is available 307, the LPC may prompt the user to submit user profiling information and portfolio configuration parameters 308 via a user interface (e.g., see FIG. 4A, etc.). For example, as shown in FIG. 4A, the user may instantiate a web-based LPC user interface to input their customer profile 401, such as, but not limited to basic information 403a (e.g., name, date of birth, address, demographic information 405a, etc.), desired milestones 403b (e.g., desired retirement age, student loan pay-off time, desired home purchase age, desired mortgage pay-off age, other expenses/savings plan, etc.), and/or the like. The user may further specify education background 405b, employment industry 405c, annual income 405d, and/or the like. In further implementations, the user may provide information as to their financial condition, such as but not limited to current asset information, property, loans/debts, and/or the like.

In one implementation, the LPC may retrieve a risk boundary based on the individual customization parameters 309. In one implementation, the LPC server may facilitate to generate a portfolio based on the risk boundary 312.

FIG. 3B provides an exemplary logic flow diagram illustrating risk boundary generation component 303 within embodiments of the LPC. In one implementation, continuing on with 302 in FIG. 3A, LPC may load various historical data 314, such as, but not limited to time series of monthly return series used in the process of constructing the risk boundary, e.g., as an Excel spreadsheet as shown in FIG. 4B, etc. For example, as shown in one implementation in FIG. 4B, the historical data may provide a list of historical dates 421a, the U.S. equity return 421b, non-US equity return 421c, U.S. investment grade debt return 421d, U.S. short term debt return 421e, and/or the like. In one implementation, when the LPC aims at generating a general risk boundary that fits for all investors, the LPC may load historical data from all investors. In another implementation, the LPC may filter and/or categorize historical investment data based on investor characteristics, such as but not limited to investor demographics, investor geographic area, investor education, individual income, investor industry, and/or the like, to generate customized and/or categorized risk boundary. For example, the LPC may generate a risk boundary for investors per different employment industry, per academic degree levels, per annual income range, per demographic group, per geographical location, and/or the like. In further implementation, the LPC may generate a risk boundary for investors with two or more and/or other combinations of individual parameters, e.g., a risk boundary for investors in the oil industry having a master and above degree, a risk boundary for lawyers in the New York City, and/or the like.

In one implementation, the LPC may load the obtained data, e.g., as obtained in the Excel spreadsheet as shown in FIG. 4B into the LPC component 316a. For example, an exemplary MatLab code segment for loading data into the LPC component may be provided in FIG. 4C, which may comprise code programs instantiated under MatLab for (i) monthly return series 423a, (ii) start dates of drawdown events 423b, (iii) starting age of glide path segment 423c, (iv) length of glide path segment 423d, (v) internal rate of return 423e, (vi) withdrawal rate 423f, and/or the like. In one implementation, the LPC may select a set of adverse scenarios (e.g., when real equity price declines greater than 20%, etc.) 316b.

In one implementation, for every age segment 317, the LPC may calculate a risk boundary. In one implementation, the LPC may select a senior age segment to start with, and proceed backwards, e.g., to start with the age segment 85-94, etc. In one implementation, the LPC may select a starting and/or ending equity allocation percentage to start with, e.g., 20%, etc., and may iterate different allocation percentages to determine an optimal equity allocation percentage. For example, for the selected starting/ending equity allocation percentages, the LPC may employ a code segment, e.g., MatLab, etc., to run a program that takes the various historical data inputs (e.g., 423a-f in FIG. 4B, etc.) and calculate an average discounted utility of a linear glide path segment (e.g., defined by a starting and ending equity allocation) over a set of adverse scenarios (e.g. the 20 largest US equity price declines) (e.g., as shown in FIG. 4D, 20 drawdown events, etc.), e.g., at 321.

For example, for investors that are loss averse around a reference wealth point FIG. 5C (a), the discounted utility of a glide path segment during and after a market event is calculated by (i) comparing, at a given time frequency (e.g. year), actual wealth implied by the glide path segment with reference wealth over the particular investment horizon (e.g. 15 years for a glide path segment of 15 years), (ii) generating a sequence of numerical utility values (representing pain for losses, pleasure for gains) for each period over the given horizon, and (iii) taking the present discounted value of this utility sequence using a particular discount factor (e.g. 0.98), which may reflect the inflation, interest rate, and/or the like. The average discounted utility of a linear glide path segment over a set of events (e.g. the 20 worst declines in the US equity market) is then defined as the average, over these events, of the discounted utility of the glide path segment associated with each event.

An exemplary pseudo-MatLab code segment for calculating average discounted utility of a linear glide path segment (e.g., 321) may be provided in FIG. 4D. In this example shown in FIG. 4D, the LPC may calculate the average discounted utility for an age segment 84-94 for a starting and ending equity allocation of 20%.

In one implementation, as shown in FIG. 5B(c), to calculate the average discounted utility 221, the LPC may follow individual wealth evolution at each age, and compare the actual wealth (e.g., based on the selected equity allocation percentage, etc.) with a reference wealth, and calculate the difference at each age. For example, if the actual wealth is below the reference wealth at certain age, it is considered as a loss; otherwise, it is considered as gain. The LPC may then use a discount factor to reflect the time (e.g., interest rate, emotional response, inflation, etc.). In further implementation, the LPC may take an average value over a set of adverse scenarios (e.g. the 20 largest US equity price declines) (e.g., different reference wealth, etc.) to obtain an average value. In one implementation, the LPC may consider average and/or worst scenarios for the utility calculation at 221. In further implementations, the LPC may customize based on various scenarios, e.g., one investor may have heavy investment allocation in equity while another investor may have heavy investment allocation in bonds.

In one implementation, the LPC may record the calculated average discounted utility for this glide path segment 324. An exemplary pseudo-MatLab code segment for recording the calculated average discounted utility (e.g., 323, etc.) may be provided in FIG. 4E. For example, as shown in FIG. 4F, the LPC may record the calculated average discounted utility for the glide path segment starting at 20% equity and ending at 20% equity.

In one implementation, the LPC may proceed to iterate other equity allocation percentages to calculate and record average discounted utility for this glide path segment. For example, if another equity allocation percentage is necessary 324 (e.g., 30%, 40%, etc.), the LPC may select a different set of allocation percentages 325, and repeatedly instantiate the glide path component at 321, and record the calculated average discounted utility for the glide path segment in at 323 for the age segment 84-94 for all starting allocations up to 90% equity converging linearly to the ending allocation of 20%. An exemplary pseudo-MatLab code segment for recording the calculated average discounted utility over varied equity allocation percentage (e.g., 325, etc.) may be provided in FIG. 4F. For example, as shown in FIG. 4E, the LPC may record the calculated average discounted utility for the glide path segment starting at 50% equity and ending at 20% equity.

In one implementation, the LPC may determine and choose the glide path segment with a highest value of average discounted utility 327 among the recorded average discounted utility values over a variety of starting allocation percentages. In one implementation, the LPC may record the starting equity allocation percentage with the highest average discounted utility value as the optimal starting equity allocation percentage 328. In the example shown in FIGS. 4B-4F, the optimal starting allocation (at age 84) is 20% equity.

In one implementation, the LPC may repeat steps 319-328 for various age segments, proceeding backwards, recording at the end of each iteration the new optimal start point in step 328, which then becomes the end point for the next iteration. For example, when there is another age segment 329 (e.g., 75-84, etc.), the LPC may use the allocation on the previous age segment as the ending equity allocation percentage for another age segment 331. For example, in one implementation, the LPC may use the optimal starting equity allocation percentage determined for the age segment 85-94 as the ending equity allocation percentage for the age segment 75-84, and proceed to obtain an optimal starting equity allocation percentage for the age segment 75-84 via 319-328. In another example, upon obtaining the optimal equity allocation percentage at the ages 85 and 94, the LPC may obtain the equity allocation percentage for the entire age segment 85-94, e.g., via a linear connection, etc. If the next age segment is 80-89, the LPC may start with the equity allocation percentage at age as the ending equity allocation percentage to repeat steps 319-328. In one implementation, the LPC may repeat the process 319-328 until all the age segments have been considered.

In one implementation, the LPC may then link the segments to obtain optimal equity exposure 332, e.g., the obtained optimal starting and ending equity allocation percentages in each age segment, etc., to obtain the optimal equity exposure, etc. In one implementation, the LPC may combine optimal equity exposure with historical and/or forecasted long term volatilities and correlations of capital market returns to obtain risk boundary (e.g., see more details in FIG. 5D).

FIGS. 5A-5F provide exemplary data charts illustrating aspects of life cycle based risk boundary generation within embodiments of the LPC. Within implementations, in the capital markets, for example, interest rates may have declined to near historically low levels amid unprecedented central bank activity around the world. In one implementation, technology innovation, combined with an increase of information about investor demographics, behavior patterns, and risk tolerances, may provide improvements in financial modeling capabilities within the investment management industry. In one implementation, while the financial landscape may have evolved differently, the LPC may construct a portfolio to help investors achieve retirement readiness by adjusting the strategic asset allocation over time. For example, the LPC may maintain an unwavering commitment to its target date strategies, as they serve as foundational solutions to help investors achieve their retirement objectives.

With reference to FIG. 5A, individual asset 502a and liabilities 502b may evolve over different ages 501. The investment process for LPC target date portfolios may focus on accumulating assets for shareholders that may produce inflation protected income equal to approximately half of an investor's final pre-retirement salary during retirement. In one implementation, the LPC may provide a combination of prudent investor contribution behavior, withdrawal behavior, and appropriate portfolio returns. In one implementation, the target date solution may be established based upon a partnership with the investors, where the LPC may build and manage an investment program that balances their return needs with appropriate risk management through both savings and retirement periods. For example, one example determinant of success in meeting this retirement investment challenge may depend upon prudent contribution and withdrawal practices (e.g., see FIG. 5A).

Within implementations, the construction of a glide path (i.e., time-varying strategic asset allocation) may be central to the LPC target date investment process to help investors achieve asset accumulation and retirement income. The glide path may comprise a long-term orientation, and balance expected return and expected risk in an investor's time horizon. For younger investors beginning to save for retirement, the glide path may be focused on capital appreciation (i.e., total return), and may be developed to generate returns that help younger investors achieve asset growth. By comparison, the objective for investors who may be well past their target retirement date is focused on income and capital preservation. For investors in between the two extremes at the ends of the age spectrum, the glide path adjusts over time to become more conservative as an investor's time horizon becomes shorter. The asset mix at each age may be constructed based on LPC capital market assumptions (CMAs)—both historical long-term and 20-year forward-looking—to produce sufficient returns that contribute to achieving the income replacement goal, while maintaining a level of risk that is consistent with an investor's age, time horizon, and risk tolerance.

In one implementation, the LPC comprise various components. For example, the secular-based capital market assumptions. The proprietary CMAs may incorporate both a long-term historical perspective and importantly, a forward-looking perspective on expected return, risk, and correlations over a 20-year period. The CMAs influence both the risk boundary and the asset allocation positioning along the age spectrum within this boundary. In another implementation, the LPC may incorporate demographics and investor/participant behavior analytics. In one implementation, the LPC may observe the characteristics and investment behavior of large populations of retirement savers, in terms of both point-in-time snapshots and trends over time. In one implementation, such observations may influence the demographic and risk assumptions that inform the glide path analysis.

Within implementation, the LPC may comprise a risk-capacity framework, employing both risk-preference and loss-recovery analysis to develop a “risk boundary” across the age spectrum. This boundary considers both investor behavior and experienced market conditions to manage asset longevity and stability in retirement. For investors, it is important to recognize that while the target date portfolios are designed to include assets that act as a primary source of retirement income, these assets may be combined with other complementary sources of income (e.g., Social Security, DB plan benefits, and other personal savings) to achieve the LPC overall retirement planning target of income replacement, e.g., equal to 85% of final salary.

In one implementation, the LPC may develop the glide path based on various elements, which are used to model and evaluate the distribution of potential outcomes for investors: 1) capital market assumptions; 2) investor/participant behavior; and 3) risk capacity, meaning an investor's tolerance and capacity for withstanding negative returns. The investment process may support LPC target date portfolios including multiple types of stress testing and scenario analysis around these assumptions, to ensure that the asset allocation and structure for the portfolios is appropriate under a range of conditions. In one implementation, capital market assumptions may provide expectations for return, risk, and correlations among asset classes over time. These expectations may inform the strategic asset allocation among stocks, bonds, and short-term investments, which in turn produce the expected risk and return profile for portfolios at each age in the time horizon.

In one implementation, the LPC may incorporate capital market assumptions that are consistent with the performance of asset classes over long-term periods. In one implementation, the LPC may develop a time-based framework to which recognizes that at any given time, asset price fluctuations are driven by a confluence of various short-term, intermediate-term, and long-term factors. In one implementation, the LPC may employs a comprehensive asset allocation approach that analyzes underlying factors and trends across three time horizons: tactical (one to 12 months), business cycle (six months to five years), and secular (five to 30 years).

In one implementation, in developing the strategic asset allocation for LPC target date strategies, the secular forecasts for capital market assumptions are an important consideration. The LPC's current secular capital market assumptions may be based specifically on a 20-year time horizon, which strikes an appropriate balance that limits the impact of temporary cyclical fluctuations and the need to frequently adjust the glide path, while remaining grounded in current market fundamentals to reflect the risk and return conditions expected for investors. In one implementation, the secular 20-year time horizon may be chosen for it is: 1) flexible enough to capture shifts in the economic and market landscape and appropriately position the glide path for investors, and 2) stable enough to be aligned with the long-term nature of the glide path and target date objective.

In one implementation, rather than relying on historical averages, LPC's research-based approach may be underpinned by fundamental analysis of the core drivers and the principal linkages between economic trends and the performance of various asset classes across all geographies. This approach may emphasize the history t about the drivers of asset that returns to generate fundamentally dynamic and forward looking expectations. In one implementation, findings from LPC's current secular capital markets assumptions may include: lower expected returns (e.g., LPC may estimate that returns for the primary asset classes (U.S. equities, non-U.S. equities, investment grade debt, and short-term debt) may be somewhat lower over the next 20 years than their long-term historical averages. This result may stem from an expectation that returns for investment grade debt may be diminished by starting from a position of low yields in the current market environment. LPC may expect that global equity returns largely will be modestly lower but roughly in line with historical results (e.g., see FIG. 5B.(a)).

In one implementation, the LPC may assume lower volatility in foreign developed-country equity markets. In foreign developed-country markets, LPC may expect lower equity market volatility compared to historical average volatility, and a slightly lower correlation of equities to investment-grade debt. In one implementation, for a portfolio diversified across the major asset classes, returns may still be able to outpace inflation. LPC's capital market assumptions may point to generally lower returns for most major asset classes over the next years. For example, FIG. 5B.(b) shows the investment process for LPC target date strategies is informed by assumptions about the behavior of participants in defined contribution retirement plans from LPC's extensive recordkeeping data.

In one implementation, given the expectation for more muted gains from bonds and cash, a higher allocation to equities will be important in pursuing long-term return objectives. The lower expected volatility of foreign developed-country equities and lower correlation with other asset classes allow for a greater allocation to equities, while maintaining a reasonable level of risk. Bonds and cash may still have much lower absolute volatility than equities, and the low correlations of their returns with equity performance will likely continue to make them key asset classes to help manage downside risk (i.e., risk of loss) within a diversified portfolio.

In one implementation, assumptions about participant behavior set the expectations for a retirement investor's role, responsibility, and behavior in achieving the income replacement objective for a target date strategy. These assumptions may include elements such as an investor's start date, contribution rate, retirement date, and retirement planning horizon (e.g., see FIG. 5B(b)). For LPC's target date portfolios, these assumptions evolve over time, based on an assessment of investor behavior, as well as expected trends in demographics.

In one implementation, as the provider of recordkeeping services for nearly 23,000 defined contribution plans and 17 million participants, LPC's database may provide insight into actual investor experience, which helps to inform the assumptions for the target date strategies. To obtain such assumptions, both cross-sectional analysis and cross-time analysis, by age groups, asset levels and other population groupings may be evaluated by LPC to understand the behavior and trends of retirement savers. The LPC may balance both current actual observations with directional observations, with an eye towards encouraging “ideal” behaviors for savers (e.g., see FIG. 5B.(b)).

In one implementation, investors may be increasingly starting to save for retirement in their 20s. There may be a rapidly growing participation rate overall among younger investors. Specifically, LPC participant experience shows a 60% participation rate today for investors in the 25-29 age group. In one implementation, investors may be increasingly delaying retirement. For example, the expected retirement age may be projected to occur at age 67 for the target date strategies. This retirement age assumption may be also aligned with the eligibility age for full social security benefits for investors born after 1960.

In one implementation, investors may not have meaningfully changed their savings (deferral) behavior. For example, regardless of the dynamic economic/market conditions over time, a greater reliance on defined contribution versus defined benefit savings for retirement, and widespread education to encourage greater savings, a range of deferral rates to be 8% for younger savers to 13% for older savers, combining both individual and “company match” deferrals. Overall, the trends in earlier and greater savings at the initial stages of the glide path, combined with two additional years of employment, improve the probability of an investor achieving approximately half of final pre-retirement salary as an income replacement goal. At the same time, the continued low contribution rates make the achievement of retirement success a significant challenge.

In one implementation, the development of the strategic asset allocation for a target date strategies may also be informed by research that assesses an investor's ability and tolerance for withstanding portfolio volatility or losses. By accounting for the capacity for risk taking of investors at each age, this framework establishes a “risk boundary” that provides additional protection against the risk of extreme market events causing a failure to meet long-term objectives.

In one implementation, while it is difficult to measure risk tolerance precisely, the modeling for LPC's target date strategies is informed by several types of data and analysis. For example, to evaluate investors' capacity for risk taking, LPC may consider both reported and actual behavior. Reported behavior includes responses by investors who provided information to LPC regarding their levels of risk tolerance. This information offers insight into what investors articulate as their perceived tolerances for portfolio volatility, risk, and losses. The data serves as a reference point for consideration when establishing the strategic asset allocation in the glide path.

In one implementation, when evaluating actual investor behavior, LPC's recordkeeping data may provide transparency into realized investor experiences by offering insight into whether the risk tolerance initially expressed by investors is consistent with the actual behavior that emerges over time. In reviewing the actual data from LPC's defined contribution recordkeeping platform, there is strong evidence to suggest that investors who were saving for retirement in strategies such as target date funds behaved in a disciplined, prudent manner by maintaining their contribution levels and positions during periods of market stress. For example, the LPC recordkeeping data shows that active participants may not meaningfully adjust their contribution rates during recent periods of market stress, which may suggest that investors in target date strategies may have a reasonable level of risk tolerance during the accumulation period, and do not react emotionally by liquidating their positions during temporary periods of market volatility or losses.

In one implementation, because a target date strategy may be designed to be a long-term holding that spans both accumulation and distribution, it is important to consider the economic and behavioral impacts for how investors may react in times of market stress and adverse short-term outcomes. While analysis on reported and actual behavior may provide insight into the short-term risk tolerance of investors, a risk capacity framework may also to consider the impact on portfolio outcomes and behavior over time. Therefore, to evaluate investor risk capacity over longer time periods, the LPC have refined quantitative framework for analysis. The refined assessment of risk capacity defines a “risk boundary” across the age spectrum, based on considerations of both investor behavior and experienced market conditions, emphasizing historical periods of market stress.

In one implementation, the LPC may include behavioral elements of quantitative framework based on the groundbreaking work on loss aversion done by behavioral economics, e.g., the Amos Tversky and Daniel Kahneman model which has been validated by others in separate studies, suggesting that individuals feel the pain of a loss twice as acutely as they enjoy the pleasure from an equivalent gain. In one implementation, in the context of target date investing, this result has both intuitive and quantitative appeal. For example, when an investor's portfolio falls short of the level of assets needed to supply adequate income in retirement, the consequences can be significant, particularly during periods of market stress. Because this experience is painful both economically and behaviorally, these outcomes should ideally be avoided more than favorable outcomes in which the portfolio exceeds the target level of assets.

In one implementation, the LPC may apply this concept specifically to a target date portfolio, any time the wealth represented by the portfolio's value falls below its expected path—for instance, during a stock-market decline—the deviation from this wealth reference point6 is considered to be “more painful” to investors than the comparable wealth that may be generated from a stock market gain (e.g., see FIG. 5B(c)). FIG. 5B(c) provides a quantitative value that is assigned to the pain a target date fund investor experiences when an actual portfolio value falls below the wealth reference point (expected portfolio value based on given assumptions) due to market declines. For example, the value of this shortfall may be twice as significant as the value of the pleasure that an investor experiences tied to an equivalent gain. As a result, LPC may define a utility function—the satisfaction from meeting the stated investment objectives (or the dissatisfaction from failing to do so)—by incorporating these loss aversion assumptions, in order to develop quantitative measures of risk tolerance at each stage of the time horizon.

In one implementation, the investment elements of the LPC quantitative framework focus on the outcomes that investors would have experienced during historical periods of significant market stress, which may be designed to capture an investor's experience and sensitivity to losses both at the time of a market decline, and in subsequent periods. Historically, severe market environments have occurred much more frequently than traditional quantitative models would expect. While quantitative models often assume that investment returns follow a normal, or bell-shaped, distribution, the actual frequency which markets have produced extreme returns has been much higher (e.g., see FIG. 5C(a)). As indicated by FIG. 5C(a), if returns were normally distributed, annualized declines greater than 30% would occur once every 60 years, with other extreme events occurring even less frequently. As FIG. 5C(a) shows, these types of unexpected events have occurred far more frequently in real-world experience. Therefore, as a baseline, the LPC may obtain results using actual market performance from the 20 worst periods for U.S. equity returns during the past 100 years. In one implementation, the LPC quantitative framework for evaluating risk capacity combines these behavioral and investment market elements by considering the investor experience during each of these 20 periods. For investors at various ages, LPC may evaluate what the portfolio balance, expected cash flows, and experience would have been during a defined time horizon, using a wide range of potential asset allocation strategies over the horizon. For each investor, the LPC may calculate the utility at the end of each year by comparing whether the portfolio's value is above or below its expected level. The overall utility, or satisfaction, for the investor's experience may be calculated by aggregating the utility values over the entire period.

FIG. 5C(b) shows quantitative modeling techniques, which may often underestimate the frequency of major U.S. equity market declines. For example, FIG. 5G shows the U.S. equity market activities. As shown at FIG. 5G(a)-(b), the U.S. equity market may have an average real return=7.4% per annum annualized standard deviation=17.6%.

FIG. 5D shows the risk capacity framework that identifies the maximum level of risk for each age, by selecting the allocation paths for investors of different ages that achieve the most favorable outcomes during the 20 worst periods of equity market declines. In one implementation, for each investor, the LPC may identify and select the asset allocation path that maximizes the investor's average utility over all of the historical periods. This asset allocation path sets a maximum level of risk capacity, or risk boundary, for each investor that focuses on protecting the portfolio and the investors' outcomes during periods of market stress. For example, at age 84, an investor has a remaining planning horizon of 10 years (see FIG. 5D, step 1, etc.). Following a quantitative process known as backward induction (i.e., determining the asset allocation for investors at younger ages by using the asset allocation for investors at older ages as an end point), the LPC may evaluate a range of possible allocation paths that invest in different combinations of stocks, bonds, and short-term assets over time, finishing at a conservative portfolio allocation (i.e., 20% equities, with 4% expected volatility) at the end of age 93. For each allocation path, the investor's utility values are calculated and evaluated, based on what the experience would have been during the 20 historical periods. The LPC may then select the allocation path that maximizes the average utility over all the periods. The risk capacity of an 84-year-old is low due to the investor's short time horizon, which results in selecting a path that maintains a conservative allocation over this entire period. For this investor, the risk capacity frame-work provides a guideline that recognizes the short time horizon and protects the investor from significant market declines when losses would be most impactful.

In one implementation, the same process may be applied for investors of different starting ages and time horizons. At age 67, an investor is entering retirement, has a reasonably long time horizon for planning, and is starting to withdraw assets from the portfolio. For this investor, the risk capacity framework provides an upper bound that is consistent with a balanced portfolio that gradually becomes more conservative as the time horizon shortens. By comparison, a younger investor has a longer time horizon and continues to make contributions to the portfolio. The results may highlight that younger investors have greater risk capacity and time to recover from periods of market stress.

FIG. 5D also shows how the application of this framework at multiple ages leads to a guideline for risk capacity at each age in the time horizon. The capacity for risk diminishes as an investor ages because the planning horizon shortens and withdrawals increase. The analysis that supports the glide path for LPC's target date strategies utilizes the participant behavior assumptions, capital market assumptions, and risk capacity methodology as research components that inform the decision-making process. The analysis framework used to develop the glide path begins by focusing on the allocations for each of the end points. These two portfolios—the accumulation portfolio, which is focused on capital appreciation, and the retirement portfolio, which seeks a balance among total return, high current income (yield), and capital preservation—are developed to achieve distinct goals at opposite ends of the risk spectrum and investor time horizon. These portfolios serve as anchors for the asset allocation in the most aggressive target date portfolio (for younger investors) and the most conservative target date portfolio (for older investors).

In one implementation, the asset allocation for the accumulation portfolio focuses on capital appreciation as the primary objective. The accumulation portfolio may be designed to produce high expected total return, while maintaining diversification across asset classes. Based on LPC's long-term capital market assumptions, combined with stochastic and empirical modeling, the strategic allocation for the accumulation portfolio includes 90% in equities and 10% in investment-grade bonds, with a long-term expected volatility of approximately 14%. This strategic allocation is expected to provide a level of risk and return that is consistent with the capital appreciation objective for investors who have a long time horizon to retirement.

In one implementation, the asset allocation for the retirement portfolio focuses on seeking a balance among total return, high current income (yield), and capital preservation. Because the objectives for the retirement portfolio are more nuanced, several types of analyses are evaluated. For example, allocations that maximize total return may also expose an investor to the greatest downside risk in times of market stress, so it is necessary to evaluate the outcomes through multiple lenses. Based on LPC's long-term capital market assumptions, combined with stochastic and empirical modeling, the strategic allocation for the retirement portfolio includes 20% equities, 40% bonds, and 40% short-term investments, with a long-term expected volatility of approximately 4%. This allocation is expected to balance the objectives for the most conservative portfolio for investors who are well past the target date, providing the potential for total return, limiting declines, and providing current income.

In one implementation, with the accumulation and retirement portfolio allocations in place, the focus of our analysis shifts to the construction of the glide path. The retirement portfolio serves as the baseline allocation in the analysis for an investor at the end of the planning horizon, while the accumulation portfolio serves as the baseline allocation for younger investors seeking capital appreciation. The quantitative empirical risk framework defines the risk boundary that acts as an upper bound on the maximum portfolio risk investors at each age. In this framework, the asset allocation for the retirement portfolio serves as an anchor point for an investor at the end of the planning horizon (age 93). The backward induction process is applied at multiple ages and for multiple time horizons, with the accumulation portfolio providing a limit on the most aggressive allocation for investors. The allocation points are then linked across the different ages to create one continuous allocation path. Using the long-term capital market expectations, this asset allocation path defines the risk boundary, or maximum risk capacity at each age for the glide path (see FIG. 5F(a)). For example, FIG. 5F(a) shows the maximum risk capacity in LPC's glide path establishes a risk boundary for risk at each age in the time horizon. In one implementation, the LPC may translate the equity exposure of a portfolio (e.g., FIG. 5E(a)) to expected portfolio risk (e.g., see FIG. 5E(b)).

In one implementation, the LPC may employ asset-liability model analysis, including testing a universe of glide paths and applying secular capital market assumptions. The final stage of the investment process applies asset-liability modeling to evaluate potential investor outcomes in the context of the overall income replacement objective. Ideally, an investor's portfolio may have precisely enough assets to generate payments equal to the desired income replacement level, or liability, during the planning horizon. In one implementation, variability in participant behavior, combined with the uncertainty and volatility of markets, creates a distribution of potential outcomes that investors may experience. In one implementation, asset liability analysis may use quantitative modeling techniques to create a distribution of outcomes that may be evaluated. From this analysis, the glide path is selected that strikes a balance between providing a high likelihood for successful outcomes, while reducing the shortfall risk that occurs when success is not achieved.

In one implementation, by combining the results of risk boundary analysis and the application of the secular CMAs, a universe of glide paths may be evaluated in an asset liability framework. The risk boundary from the quantitative empirical risk framework provides an upper bound for the level of risk that is appropriate for investors at each age in the time horizon. Glide paths may then be considered with portfolios that include varying levels of expected risk, based on LPC's secular capital market assumptions, that are less than or equal to the risk boundary at each age (see FIG. 5F(a)).

FIG. 5F(c) shows the LPC using asset-liability modeling, glide paths are evaluated with varying levels of risk that are less than or equal to the risk boundary at each age.

In one implementation, in combination with the demographic assumptions for investor behavior, the allocation paths produce a range of outcomes that may be evaluated to highlight the trade-offs in having a more aggressive or conservative asset allocation approach over time. When assessing potential outcomes in a target date strategy, it is important to evaluate reward and risk relative to the income replacement goal for investors. While the risk and return results for traditional mutual funds are often measured against standard market benchmarks (e.g., S&P 500 Index for equity strategies, BC Aggregate Index for bond strategies, etc.), the asset-liability objective of a target date strategy requires a different type of measurement to evaluate risk and reward relative to a retirement liability.

In one implementation, in the context of the target date strategies, “reward” may be defined as success in achieving the income replacement objective—having sufficient inflation-adjusted income to last from the retirement date at age 67, until the end of the planning horizon at age 93. LPC's target date portfolios strive to achieve successful outcomes in a high proportion of scenarios. “Risk” may be defined as those outcomes when success is not achieved, and there is not sufficient income to last for the entire planning horizon. For measurement purposes, outcomes may be created using simulation techniques, with risk focused on the bottom 10% of scenarios. “Shortfall” may be defined as the number of years in the planning period for which there is insufficient income. LPC's target date portfolios may strive to achieve successful outcomes, while limiting average shortfall in the worst scenarios.

In one implementation, the LPC results from the asset-liability analysis may show that glide paths with higher equity allocations at each point in time produce a higher probability of success and lower shortfall risk relative to the results for more conservative strategies. These glide paths may be preferred because of the interrelationship of investor behavior and capital market assumptions. In one implementation, because current levels of investor contributions (8% to 13%) alone may not be sufficient to provide inflation-protected income through the planning period, investment returns are needed over time. When evaluating potential glide paths, strategies with higher equity exposure may be preferred to provide this return, in part because LPC's secular capital market assumptions are favorable for equities, relative to the lower expectations for fixed income and short term asset classes. While a more aggressive glide path may increase the likelihood for achieving successful outcomes, the expected risk in the strategic asset allocation may be limited to the risk boundary for each age in the time horizon, to provide protection for investors in periods of market stress.

In one implementation, LPC's glide path may establish that the long-term strategic asset allocation that balances return and risk at each point in the time horizon, while striving to achieve the income replacement objective, assuming appropriate investor behavior. In one implementation, establishing a risk capacity framework and applying LPC's secular CMAs in the asset-liability model selected for LPC's target date strategies may produce an appropriate balance for achieving a reasonable probability of success, limiting shortfall risk, and reflecting investor risk capacity over time (e.g., see FIG. 5F(b)).

FIG. 5F(b) provides exemplary outcome of LPC's investment process which produces a glide path for LPC's target date strategies that may help investors' achieve their retirement objectives. In one implementation, retirement investors may recognize that achieving adequate income replacement throughout retirement requires a combination of both investor contributions and portfolio returns. In the absence of consistent and adequate investor contributions, there is a low likelihood that an individual will have sufficient assets at retirement, regardless of the asset allocation strategy that is implemented. According to LPC's analysis, investors looking to boost their probability of success have options that can be implemented. Specifically, making only modest adjustments to the following participant behaviors are some of the ways to increase the likelihood of achieving a successful outcome, e.g., increasing the contribution rate, starting saving/contributing earlier, delaying retirement age, lowering expected income replacement level, and/or the like. In one implementation, LPC may continue to focus on the investment aspects of the retirement readiness partnership, and we continuously evaluate opportunities to improve outcomes for investors.

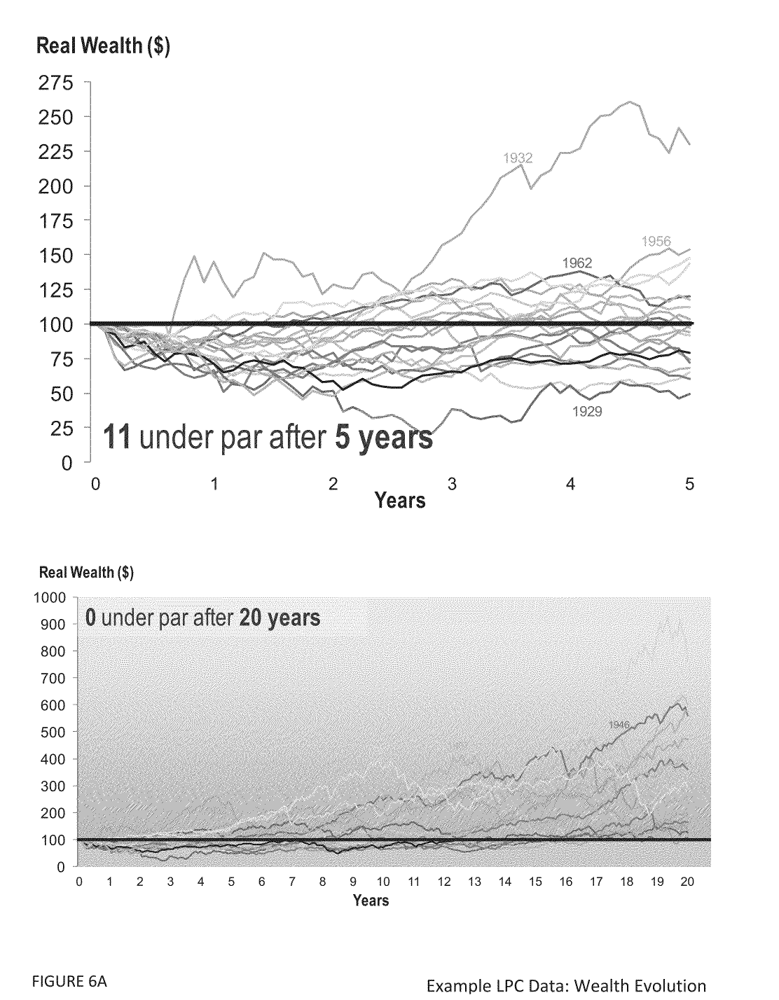

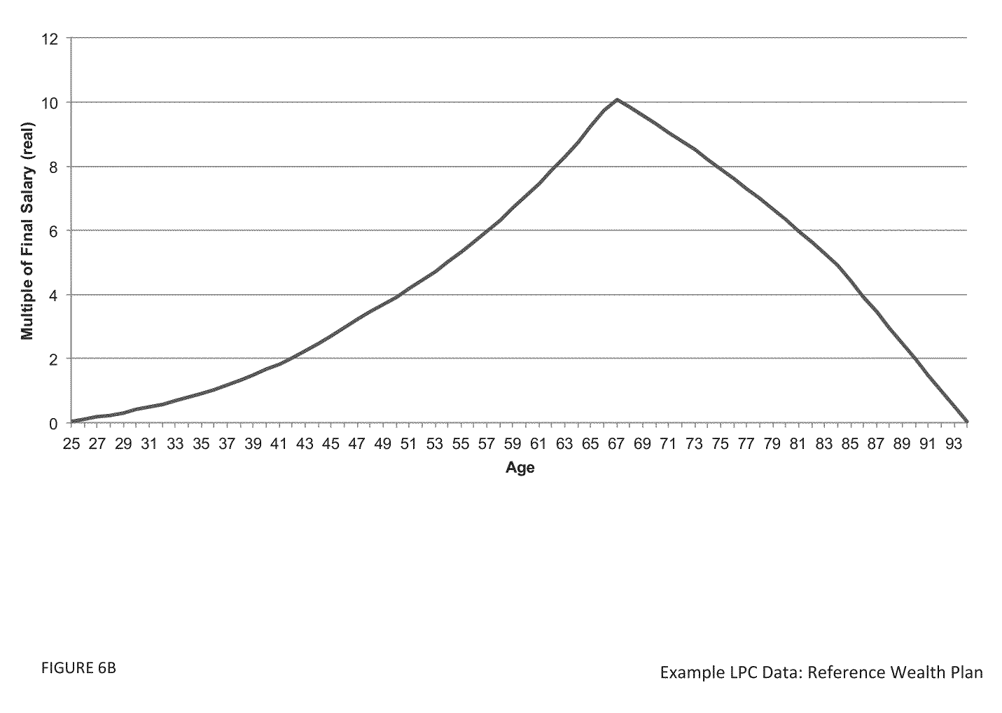

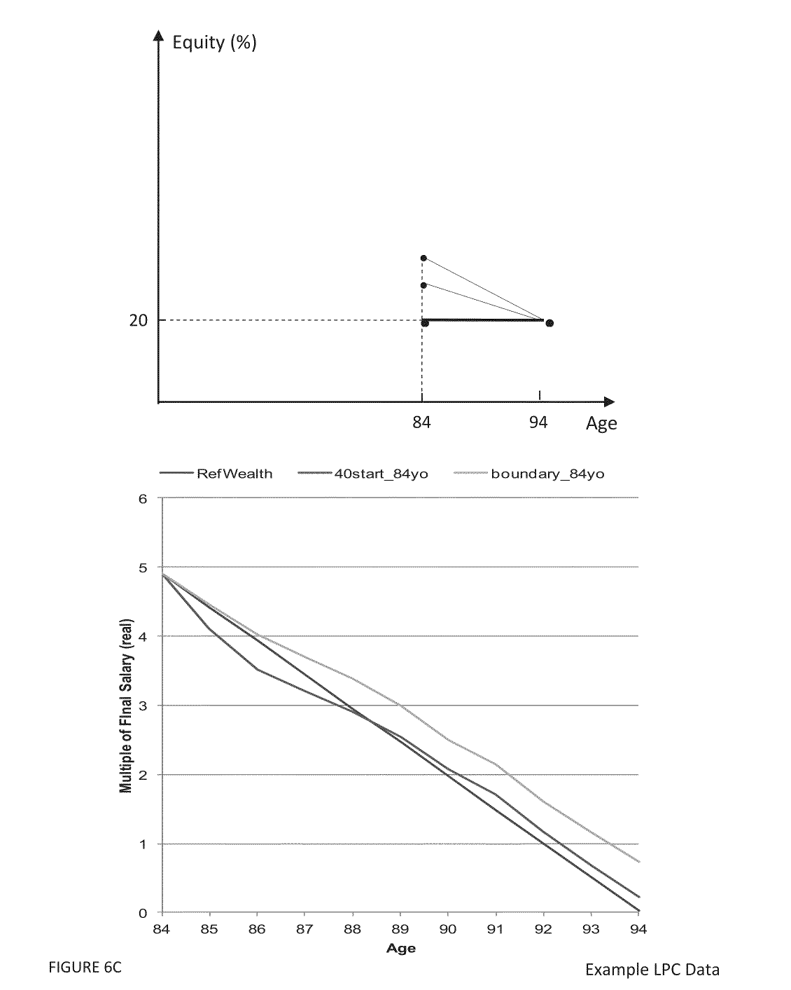

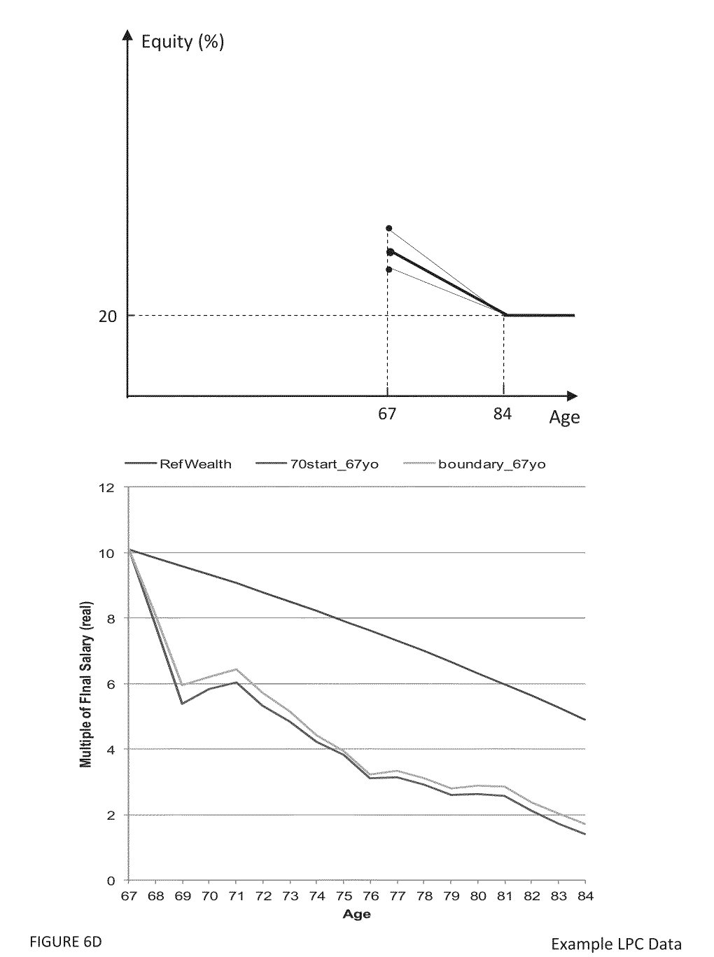

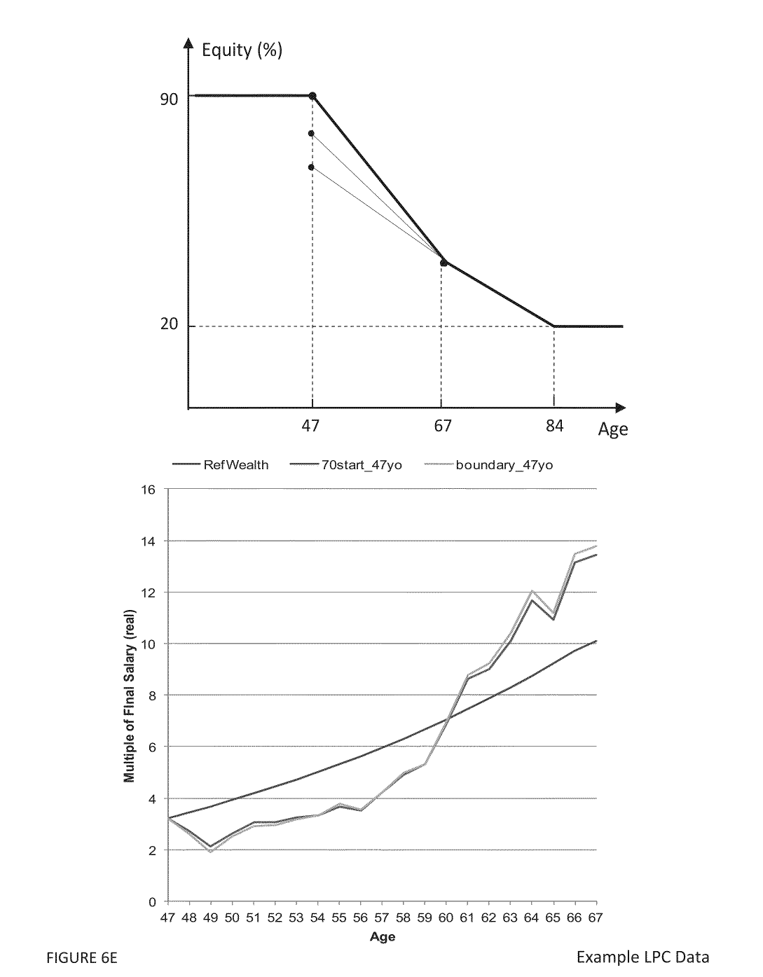

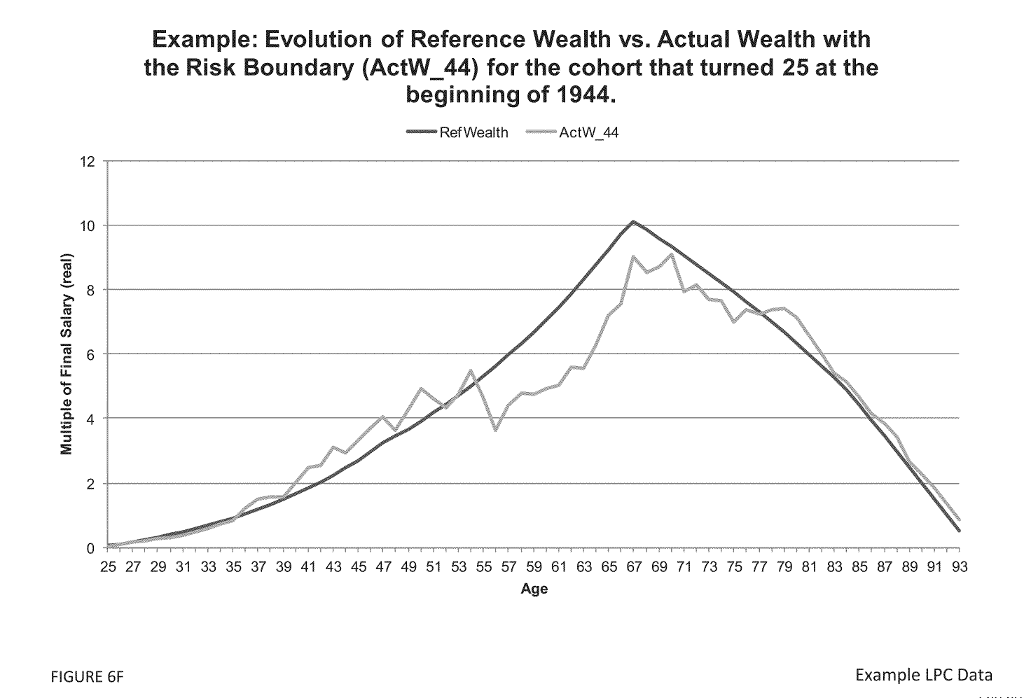

FIGS. 6A-6F provide additional data charts illustrating embodiments of the LPC. Within implementations, the LPC may establish a risk framework based on robust control. The LPC may optimize client objective over the set of worst case scenarios, and provide age-specific maximum risk capacity (e.g., the risk spine, etc.). For example, risk spine may include the 20 worst drawdown events in the US equity market (e.g., FIG. 6A provide an exemplary data chart illustrating evolution fo real wealth during and after drawdowns, etc.) recovery time and investment horizon, people dislike losses 2× as much as they like gains, and/or the like. FIG. 6B provides an exemplary data chart illustrating a reference wealth plan, e.g., 1.5% annual merit increase, 10% at age 25 to 15% at age 66 contribution, 50 withdrawal of salary at retirement through age 93, age-specific internal rates of return based on long term capital market returns and an increasingly conservative asset mix, and/or the like. FIGS. 6C-6E provide exemplary data charts illustrating backward induction to generate a risk boundary. For example, as shown in FIG. 6C, the LPC may start from the age segment 84-94 to determine the optimal equity allocation percentage at the age 84 and 94, e.g., FIG. 6C shows september for a 84 year old holding the spine or a 40/60 portfolio converging linearly to the spine over 10 years. With reference to FIG. 6D, the LPC may continue on to determine the optimal equity allocation percentage at the age 67, e.g., FIG. 6D shows 1973 for a 67 year old holding the Spine or a 70/30 portfolio converging linearly to the Spine over 17 years. With reference to FIG. 6E, the LPC may continue on to determine the optimal equity allocation percentage at the age 47, e.g., FIG. 6E shows the evolution of real wealth since January 1973 for a 47 year old holding the Spine or a 70/30 portfolio converging linearly to the Spine over 20 years.

As shown in FIG. 5E, the LPC may consider various age intervals, pick the segments with the highest average discounted utility over the 20 drawdown episodes, link the optimal segments smoothly to obtain the Risk Spine. In one implementation, at each age, the Risk Spine may impose a portfolio volatility constraint that the glidepath may satisfy. FIG. 6F shows exemplary data plot illustrating historical evolution of Reference Wealth vs. Actual Wealth with the Optimal Equity Exposure (Risk Boundary) for the cohort than turned 25 in 1944.

### LPC Controller

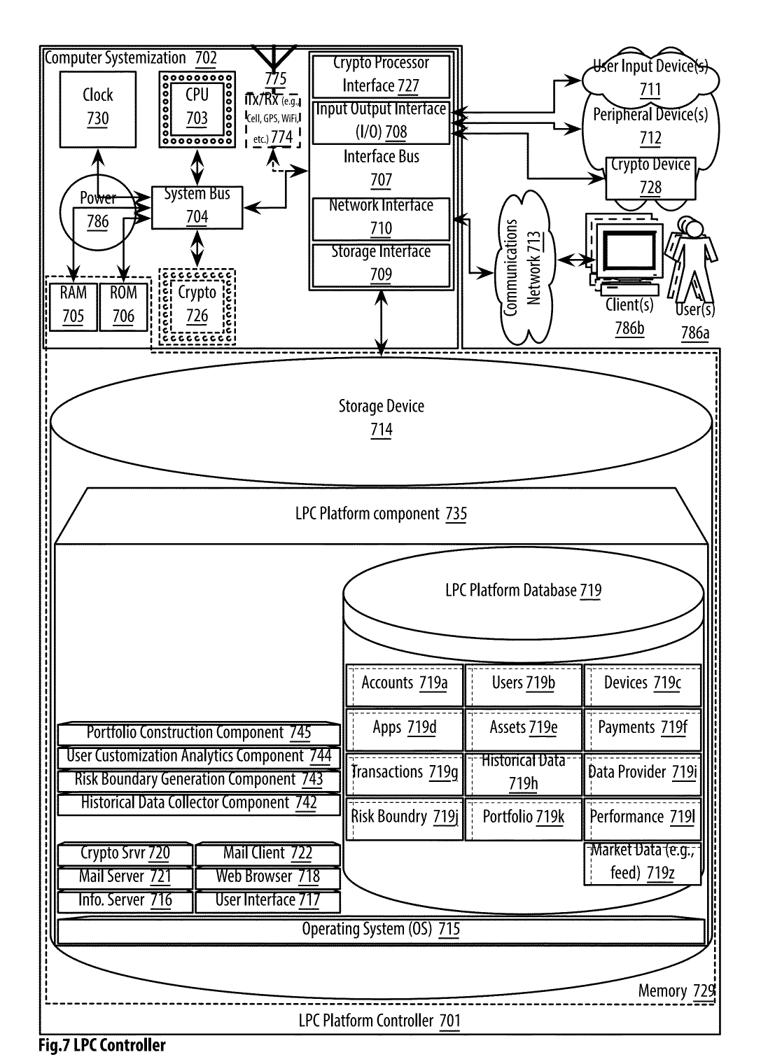

FIG. 7 shows a block diagram illustrating embodiments of a LPC controller. In this embodiment, the LPC controller 701 may serve to aggregate, process, store, search, serve, identify, instruct, generate, match, and/or facilitate interactions with a computer through information and financial network technologies, and/or other related data.

Typically, users, which may be people and/or other systems, may engage information technology systems (e.g., computers) to facilitate information processing. In turn, computers employ processors to process information; such processors 703 may be referred to as central processing units (CPU). One form of processor is referred to as a microprocessor. CPUs use communicative circuits to pass binary encoded signals acting as instructions to enable various operations. These instructions may be operational and/or data instructions containing and/or referencing other instructions and data in various processor accessible and operable areas of memory 729 (e.g., registers, cache memory, random access memory, etc.). Such communicative instructions may be stored and/or transmitted in batches (e.g., batches of instructions) as programs and/or data components to facilitate desired operations. These stored instruction codes, e.g., programs, may engage the CPU circuit components and other motherboard and/or system components to perform desired operations. One type of program is a computer operating system, which, may be executed by CPU on a computer; the operating system enables and facilitates users to access and operate computer information technology and resources. Some resources that may be employed in information technology systems include: input and output mechanisms through which data may pass into and out of a computer; memory storage into which data may be saved; and processors by which information may be processed. These information technology systems may be used to collect data for later retrieval, analysis, and manipulation, which may be facilitated through a database program. These information technology systems provide interfaces that allow users to access and operate various system components.

In one embodiment, the LPC controller 701 may be connected to and/or communicate with entities such as, but not limited to: one or more users from user input devices 711; peripheral devices 712; an optional cryptographic processor device 728; and/or a communications network 713.

Networks are commonly thought to comprise the interconnection and interoperation of clients, servers, and intermediary nodes in a graph topology. It should be noted that the term “server” as used throughout this application refers generally to a computer, other device, program, or combination thereof that processes and responds to the requests of remote users across a communications network. Servers serve their information to requesting “clients.” The term “client” as used herein refers generally to a computer, program, other device, user and/or combination thereof that is capable of processing and making requests and obtaining and processing any responses from servers across a communications network. A computer, other device, program, or combination thereof that facilitates, processes information and requests, and/or furthers the passage of information from a source user to a destination user is commonly referred to as a “node.” Networks are generally thought to facilitate the transfer of information from source points to destinations. A node specifically tasked with furthering the passage of information from a source to a destination is commonly called a “router.” There are many forms of networks such as Local Area Networks (LANs), Pico networks, Wide Area Networks (WANs), Wireless Networks (WLANs), etc. For example, the Internet is generally accepted as being an interconnection of a multitude of networks whereby remote clients and servers may access and interoperate with one another.

The LPC controller 701 may be based on computer systems that may comprise, but are not limited to, components such as: a computer systemization 702 connected to memory 729.

### Computer Systemization

A computer systemization 702 may comprise a clock 730, central processing unit (“CPU(s)” and/or “processor(s)” (these terms are used interchangeable throughout the disclosure unless noted to the contrary)) 703, a memory 729 (e.g., a read only memory (ROM) 706, a random access memory (RAM) 705, etc.), and/or an interface bus 707, and most frequently, although not necessarily, are all interconnected and/or communicating through a system bus 704 on one or more (mother)board(s) 702 having conductive and/or otherwise transportive circuit pathways through which instructions (e.g., binary encoded signals) may travel to effectuate communications, operations, storage, etc. The computer systemization may be connected to a power source 786; e.g., optionally the power source may be internal. Optionally, a cryptographic processor 726 may be connected to the system bus. In another embodiment, the cryptographic processor and/or transceivers (e.g., ICs) 774 may be connected as either internal and/or external peripheral devices 712 via the interface bus I/O 708 (not pictured) and/or directly via the interface bus 707. In turn, the transceivers may be connected to antenna(s) 775, thereby effectuating wireless transmission and reception of various communication and/or sensor protocols; for example the antenna(s) may connect to various transceiver chipsets (depending on deployment needs), including: Broadcom BCM4329FKUBG transceiver chip (e.g., providing 802.11n, Bluetooth 2.1+ EDR, FM, etc.); a Broadcom BCM4750IUB8 receiver chip (e.g., GPS); a Broadcom BCM4335 transceiver chip (e.g., providing 2G, 3G, and 4G long-term evolution (LTE) cellular communications; 802.11ac, Bluetooth 4.0 low energy (LE) (e.g., beacon features)); an Infineon Technologies X-Gold 618-PMB9800 transceiver chip (e.g., providing 2G/3G HSDPA/HSUPA communications); a MediaTek MT6620 transceiver chip (e.g., providing 802.11a/b/g/n, Bluetooth 4.0 LE, FM, global positioning system (GPS) (thereby allowing LPC controller to determine its location); a Texas Instruments WiLink WL1283 transceiver chip (e.g., providing 802.11n, Bluetooth 3.0, FM, GPS); and/or the like. The system clock typically has a crystal oscillator and generates a base signal through the computer systemization's circuit pathways. The clock is typically coupled to the system bus and various clock multipliers that will increase or decrease the base operating frequency for other components interconnected in the computer systemization. The clock and various components in a computer systemization drive signals embodying information throughout the system. Such transmission and reception of instructions embodying information throughout a computer systemization may be commonly referred to as communications. These communicative instructions may further be transmitted, received, and the cause of return and/or reply communications beyond the instant computer systemization to: communications networks, input devices, other computer systemizations, peripheral devices, and/or the like. It should be understood that in alternative embodiments, any of the above components may be connected directly to one another, connected to the CPU, and/or organized in numerous variations employed as exemplified by various computer systems.

The CPU comprises at least one high-speed data processor adequate to execute program components for executing user and/or system-generated requests. The CPU is often packaged in a number of formats varying from large mainframe computers, down to mini computers, servers, desktop computers, laptops, netbooks, tablets (e.g., iPads, Android and Windows tablets, etc.), mobile smartphones (e.g., iPhones, Android and Windows phones, etc.), wearable devise (e.g., watches, glasses, goggles (e.g., Google Glass), etc.), and/or the like. Often, the processors themselves will incorporate various specialized processing units, such as, but not limited to: integrated system (bus) controllers, memory management control units, floating point units, and even specialized processing sub-units like graphics processing units, digital signal processing units, and/or the like. Additionally, processors may include internal fast access addressable memory, and be capable of mapping and addressing memory 729 beyond the processor itself; internal memory may include, but is not limited to: fast registers, various levels of cache memory (e.g., level 1, 2, 3, etc.), RAM, etc. The processor may access this memory through the use of a memory address space that is accessible via instruction address, which the processor can construct and decode allowing it to access a circuit path to a specific memory address space having a memory state. The CPU may be a microprocessor such as: AMD's Athlon, Duron and/or Opteron; Apple's A series of processors (e.g., A5, A6, A7, etc.); ARM's application, embedded and secure processors; IBM and/or Motorola's DragonBall and PowerPC; IBM's and Sony's Cell processor; Intel's 80X86 series (e.g., 80386, 80486), Pentium, Celeron, Core (2) Duo, i series (e.g., i3, i5, i7, etc.), Itanium, Xeon, and/or XScale; Motorola's 680X0 series (e.g., 68020, 68030, 68040, etc.); and/or the like processor(s). The CPU interacts with memory through instruction passing through conductive and/or transportive conduits (e.g., (printed) electronic and/or optic circuits) to execute stored instructions (i.e., program code) according to conventional data processing techniques. Such instruction passing facilitates communication within the LPC controller and beyond through various interfaces. Should processing requirements dictate a greater amount speed and/or capacity, distributed processors (e.g., Distributed LPC), mainframe, multi-core, parallel, and/or super-computer architectures may similarly be employed. Alternatively, should deployment requirements dictate greater portability, smaller Personal Digital Assistants (PDAs) may be employed.

Depending on the particular implementation, features of the LPC may be achieved by implementing a microcontroller such as CAST's R8051XC2 microcontroller; Intel's MCS 51 (i.e., 8051 microcontroller); and/or the like. Also, to implement certain features of the LPC, some feature implementations may rely on embedded components, such as: Application-Specific Integrated Circuit (“ASIC”), Digital Signal Processing (“DSP”), Field Programmable Gate Array (“FPGA”), and/or the like embedded technology. For example, any of the LPC component collection (distributed or otherwise) and/or features may be implemented via the microprocessor and/or via embedded components; e.g., via ASIC, coprocessor, DSP, FPGA, and/or the like. Alternately, some implementations of the LPC may be implemented with embedded components that are configured and used to achieve a variety of features or signal processing.

Depending on the particular implementation, the embedded components may include software solutions, hardware solutions, and/or some combination of both hardware/software solutions. For example, LPC features discussed herein may be achieved through implementing FPGAs, which are a semiconductor devices containing programmable logic components called “logic blocks”, and programmable interconnects, such as the high performance FPGA Virtex series and/or the low cost Spartan series manufactured by Xilinx. Logic blocks and interconnects can be programmed by the customer or designer, after the FPGA is manufactured, to implement any of the LPC features. A hierarchy of programmable interconnects allow logic blocks to be interconnected as needed by the LPC system designer/administrator, somewhat like a one-chip programmable breadboard. An FPGA's logic blocks can be programmed to perform the operation of basic logic gates such as AND, and XOR, or more complex combinational operators such as decoders or mathematical operations. In most FPGAs, the logic blocks also include memory elements, which may be circuit flip-flops or more complete blocks of memory. In some circumstances, the LPC may be developed on regular FPGAs and then migrated into a fixed version that more resembles ASIC implementations. Alternate or coordinating implementations may migrate LPC controller features to a final ASIC instead of or in addition to FPGAs. Depending on the implementation all of the aforementioned embedded components and microprocessors may be considered the “CPU” and/or “processor” for the LPC.

### Power Source

The power source 786 may be of any standard form for powering small electronic circuit board devices such as the following power cells: alkaline, lithium hydride, lithium ion, lithium polymer, nickel cadmium, solar cells, and/or the like. Other types of AC or DC power sources may be used as well. In the case of solar cells, in one embodiment, the case provides an aperture through which the solar cell may capture photonic energy. The power cell 786 is connected to at least one of the interconnected subsequent components of the LPC thereby providing an electric current to all subsequent components. In one example, the power source 786 is connected to the system bus component 704. In an alternative embodiment, an outside power source 786 is provided through a connection across the I/O 708 interface. For example, a USB and/or IEEE 1394 connection carries both data and power across the connection and is therefore a suitable source of power.

### Interface Adapters

Interface bus(ses) 707 may accept, connect, and/or communicate to a number of interface adapters, conventionally although not necessarily in the form of adapter cards, such as but not limited to: input output interfaces (I/O) 708, storage interfaces 709, network interfaces 710, and/or the like. Optionally, cryptographic processor interfaces 727 similarly may be connected to the interface bus. The interface bus provides for the communications of interface adapters with one another as well as with other components of the computer systemization. Interface adapters are adapted for a compatible interface bus. Interface adapters conventionally connect to the interface bus via a slot architecture. Conventional slot architectures may be employed, such as, but not limited to: Accelerated Graphics Port (AGP), Card Bus, (Extended) Industry Standard Architecture ((E)ISA), Micro Channel Architecture (MCA), NuBus, Peripheral Component Interconnect (Extended) (PCI(X)), PCI Express, Personal Computer Memory Card International Association (PCMCIA), and/or the like.

Storage interfaces 709 may accept, communicate, and/or connect to a number of storage devices such as, but not limited to: storage devices 714, removable disc devices, and/or the like. Storage interfaces may employ connection protocols such as, but not limited to: (Ultra) (Serial) Advanced Technology Attachment (Packet Interface) ((Ultra) (Serial) ATA(PI)) (Enhanced) Integrated Drive Electronics ((E)IDE), Institute of Electrical and Electronics Engineers (IEEE) 1394, fiber channel, Small Computer Systems Interface (SCSI), Universal Serial Bus (USB), and/or the like.

Network interfaces 710 may accept, communicate, and/or connect to a communications network 713. Through a communications network 713, the LPC controller is accessible through remote clients 733b (e.g., computers with web browsers) by users 733a. Network interfaces may employ connection protocols such as, but not limited to: direct connect, Ethernet (thick, thin, twisted pair 10/100/1000/10000 Base T, and/or the like), Token Ring, wireless connection such as IEEE 802.11a-x, and/or the like. Should processing requirements dictate a greater amount speed and/or capacity, distributed network controllers (e.g., Distributed LPC), architectures may similarly be employed to pool, load balance, and/or otherwise decrease/increase the communicative bandwidth required by the LPC controller. A communications network may be any one and/or the combination of the following: a direct interconnection; the Internet; Interplanetary Internet (e.g., Coherent File Distribution Protocol (CFDP), Space Communications Protocol Specifications (SCPS), etc.); a Local Area Network (LAN); a Metropolitan Area Network (MAN); an Operating Missions as Nodes on the Internet (OMNI); a secured custom connection; a Wide Area Network (WAN); a wireless network (e.g., employing protocols such as, but not limited to a cellular, WiFi, Wireless Application Protocol (WAP), I-mode, and/or the like); and/or the like. A network interface may be regarded as a specialized form of an input output interface. Further, multiple network interfaces 710 may be used to engage with various communications network types 713. For example, multiple network interfaces may be employed to allow for the communication over broadcast, multicast, and/or unicast networks.

Input Output interfaces (I/O) 708 may accept, communicate, and/or connect to user input devices 711, peripheral devices 712, cryptographic processor devices 728, and/or the like. I/O may employ connection protocols such as, but not limited to: audio: analog, digital, monaural, RCA, stereo, and/or the like; data: Apple Desktop Bus (ADB), IEEE 1394a-b, serial, universal serial bus (USB); infrared; joystick; keyboard; midi; optical; PC AT; PS/2; parallel; radio; touch interfaces: capacitive, optical, resistive, etc. displays; video interface: Apple Desktop Connector (ADC), BNC, coaxial, component, composite, digital, Digital Visual Interface (DVI), (mini) displayport, high-definition multimedia interface (HDMI), RCA, RF antennae, S-Video, VGA, and/or the like; wireless transceivers: 802.11a/ac/b/g/n/x; Bluetooth; cellular (e.g., code division multiple access (CDMA), high speed packet access (HSPA(+)), high-speed downlink packet access (HSDPA), global system for mobile communications (GSM), long term evolution (LTE), WiMax, etc.); and/or the like. One typical output device may include a video display, which typically comprises a Cathode Ray Tube (CRT) or Liquid Crystal Display (LCD) based monitor with an interface (e.g., DVI circuitry and cable) that accepts signals from a video interface, may be used. The video interface composites information generated by a computer systemization and generates video signals based on the composited information in a video memory frame. Another output device is a television set, which accepts signals from a video interface. Typically, the video interface provides the composited video information through a video connection interface that accepts a video display interface (e.g., an RCA composite video connector accepting an RCA composite video cable; a DVI connector accepting a DVI display cable, etc.).

User input devices 711 often are a type of peripheral device 512 (see below) and may include: card readers, dongles, finger print readers, gloves, graphics tablets, joysticks, keyboards, microphones, mouse (mice), remote controls, retina readers, touch screens (e.g., capacitive, resistive, etc.), trackballs, trackpads, sensors (e.g., accelerometers, ambient light, GPS, gyroscopes, proximity, etc.), styluses, and/or the like.

Peripheral devices 712 may be connected and/or communicate to I/O and/or other facilities of the like such as network interfaces, storage interfaces, directly to the interface bus, system bus, the CPU, and/or the like. Peripheral devices may be external, internal and/or part of the LPC controller. Peripheral devices may include: antenna, audio devices (e.g., line-in, line-out, microphone input, speakers, etc.), cameras (e.g., still, video, webcam, etc.), dongles (e.g., for copy protection, ensuring secure transactions with a digital signature, and/or the like), external processors (for added capabilities; e.g., crypto devices 528), force-feedback devices (e.g., vibrating motors), network interfaces, printers, scanners, storage devices, transceivers (e.g., cellular, GPS, etc.), video devices (e.g., goggles, monitors, etc.), video sources, visors, and/or the like. Peripheral devices often include types of input devices (e.g., cameras).

It should be noted that although user input devices and peripheral devices may be employed, the LPC controller may be embodied as an embedded, dedicated, and/or monitor-less (i.e., headless) device, wherein access would be provided over a network interface connection.

Cryptographic units such as, but not limited to, microcontrollers, processors 726, interfaces 727, and/or devices 728 may be attached, and/or communicate with the LPC controller. A MC68HC16 microcontroller, manufactured by Motorola Inc., may be used for and/or within cryptographic units. The MC68HC16 microcontroller utilizes a 16-bit multiply-and-accumulate instruction in the 16 MHz configuration and requires less than one second to perform a 512-bit RSA private key operation. Cryptographic units support the authentication of communications from interacting agents, as well as allowing for anonymous transactions. Cryptographic units may also be configured as part of the CPU. Equivalent microcontrollers and/or processors may also be used. Other commercially available specialized cryptographic processors include: Broadcom's CryptoNetX and other Security Processors; nCipher's nShield; SafeNet's Luna PCI (e.g., 7100) series; Semaphore Communications' 40 MHz Roadrunner 184; Sun's Cryptographic Accelerators (e.g., Accelerator 6000 PCIe Board, Accelerator 500 Daughtercard); Via Nano Processor (e.g., L2100, L2200, U2400) line, which is capable of performing 500+ MB/s of cryptographic instructions; VLSI Technology's 33 MHz 6868; and/or the like.

### Memory

Generally, any mechanization and/or embodiment allowing a processor to affect the storage and/or retrieval of information is regarded as memory 729. However, memory is a fungible technology and resource, thus, any number of memory embodiments may be employed in lieu of or in concert with one another. It is to be understood that the LPC controller and/or a computer systemization may employ various forms of memory 729. For example, a computer systemization may be configured wherein the operation of on-chip CPU memory (e.g., registers), RAM, ROM, and any other storage devices are provided by a paper punch tape or paper punch card mechanism; however, such an embodiment would result in an extremely slow rate of operation. In a typical configuration, memory 729 will include ROM 706, RAM 705, and a storage device 714. A storage device 714 may be any conventional computer system storage. Storage devices may include: an array of devices (e.g., Redundant Array of Independent Disks (RAID)); a drum; a (fixed and/or removable) magnetic disk drive; a magneto-optical drive; an optical drive (i.e., Blueray, CD ROM/RAM/Recordable (R)/ReWritable (RW), DVD R/RW, HD DVD R/RW etc.); RAM drives; solid state memory devices (USB memory, solid state drives (SSD), etc.); other processor-readable storage mediums; and/or other devices of the like. Thus, a computer systemization generally requires and makes use of memory.

### Component Collection

The memory 729 may contain a collection of program and/or database components and/or data such as, but not limited to: operating system component(s) 715 (operating system); information server component(s) 716 (information server); user interface component(s) 717 (user interface); Web browser component(s) 718 (Web browser); database(s) 719; mail server component(s) 721; mail client component(s) 722; cryptographic server component(s) 720 (cryptographic server); the LPC component(s) 735; and/or the like (i.e., collectively a component collection). These components may be stored and accessed from the storage devices and/or from storage devices accessible through an interface bus. Although non-conventional program components such as those in the component collection, typically, are stored in a local storage device 714, they may also be loaded and/or stored in memory such as: peripheral devices, RAM, remote storage facilities through a communications network, ROM, various forms of memory, and/or the like.

### Operating System

The operating system component 715 is an executable program component facilitating the operation of the LPC controller. Typically, the operating system facilitates access of I/O, network interfaces, peripheral devices, storage devices, and/or the like. The operating system may be a highly fault tolerant, scalable, and secure system such as: Apple's Macintosh OS X (Server); AT&T Plan 9; Be OS; Google's Chrome; Microsoft's Windows 7/8; Unix and Unix-like system distributions (such as AT&T's UNIX; Berkley Software Distribution (BSD) variations such as FreeBSD, NetBSD, OpenBSD, and/or the like; Linux distributions such as Red Hat, Ubuntu, and/or the like); and/or the like operating systems. However, more limited and/or less secure operating systems also may be employed such as Apple Macintosh OS, IBM OS/2, Microsoft DOS, Microsoft Windows 2000/2003/3.1/95/98/CE/Millenium/Mobile/NT/Vista/XP (Server), Palm OS, and/or the like. Additionally, for robust mobile deployment applications, mobile operating systems may be used, such as: Apple's iOS; China Operating System COS; Google's Android; Microsoft Windows RT/Phone; Palm's WebOS; Samsung/Intel's Tizen; and/or the like. An operating system may communicate to and/or with other components in a component collection, including itself, and/or the like. Most frequently, the operating system communicates with other program components, user interfaces, and/or the like. For example, the operating system may contain, communicate, generate, obtain, and/or provide program component, system, user, and/or data communications, requests, and/or responses. The operating system, once executed by the CPU, may enable the interaction with communications networks, data, I/O, peripheral devices, program components, memory, user input devices, and/or the like. The operating system may provide communications protocols that allow the LPC controller to communicate with other entities through a communications network 713. Various communication protocols may be used by the LPC controller as a subcarrier transport mechanism for interaction, such as, but not limited to: multicast, TCP/IP, UDP, unicast, and/or the like.

### Information Server

An information server component 716 is a stored program component that is executed by a CPU. The information server may be a conventional Internet information server such as, but not limited to Apache Software Foundation's Apache, Microsoft's Internet Information Server, and/or the like. The information server may allow for the execution of program components through facilities such as Active Server Page (ASP), ActiveX, (ANSI) (Objective-) C (++), C# and/or .NET, Common Gateway Interface (CGI) scripts, dynamic (D) hypertext markup language (HTML), FLASH, Java, JavaScript, Practical Extraction Report Language (PERL), Hypertext Pre-Processor (PHP), pipes, Python, wireless application protocol (WAP), WebObjects, and/or the like. The information server may support secure communications protocols such as, but not limited to, File Transfer Protocol (FTP); HyperText Transfer Protocol (HTTP); Secure Hypertext Transfer Protocol (HTTPS), Secure Socket Layer (SSL), messaging protocols (e.g., America Online (AOL) Instant Messenger (AIM), Application Exchange (APEX), ICQ, Internet Relay Chat (IRC), Microsoft Network (MSN) Messenger Service, Presence and Instant Messaging Protocol (PRIM), Internet Engineering Task Force's (IETF's) Session Initiation Protocol (SIP), SIP for Instant Messaging and Presence Leveraging Extensions (SIMPLE), open XML-based Extensible Messaging and Presence Protocol (XMPP) (i.e., Jabber or Open Mobile Alliance's (OMA's) Instant Messaging and Presence Service (IMPS)), Yahoo! Instant Messenger Service, and/or the like. The information server provides results in the form of Web pages to Web browsers, and allows for the manipulated generation of the Web pages through interaction with other program components. After a Domain Name System (DNS) resolution portion of an HTTP request is resolved to a particular information server, the information server resolves requests for information at specified locations on the LPC controller based on the remainder of the HTTP request. For example, a request such as http://123.124.125.126/myInformation.html might have the IP portion of the request “123.124.125.126” resolved by a DNS server to an information server at that IP address; that information server might in turn further parse the http request for the “/myInformation.html” portion of the request and resolve it to a location in memory containing the information “myInformation.html.” Additionally, other information serving protocols may be employed across various ports, e.g., FTP communications across port 21, and/or the like. An information server may communicate to and/or with other components in a component collection, including itself, and/or facilities of the like. Most frequently, the information server communicates with the LPC database 719, operating systems, other program components, user interfaces, Web browsers, and/or the like.

Access to the LPC database may be achieved through a number of database bridge mechanisms such as through scripting languages as enumerated below (e.g., CGI) and through inter-application communication channels as enumerated below (e.g., CORBA, WebObjects, etc.). Any data requests through a Web browser are parsed through the bridge mechanism into appropriate grammars as required by the LPC. In one embodiment, the information server would provide a Web form accessible by a Web browser. Entries made into supplied fields in the Web form are tagged as having been entered into the particular fields, and parsed as such. The entered terms are then passed along with the field tags, which act to instruct the parser to generate queries directed to appropriate tables and/or fields. In one embodiment, the parser may generate queries in standard SQL by instantiating a search string with the proper join/select commands based on the tagged text entries, wherein the resulting command is provided over the bridge mechanism to the LPC as a query. Upon generating query results from the query, the results are passed over the bridge mechanism, and may be parsed for formatting and generation of a new results Web page by the bridge mechanism. Such a new results Web page is then provided to the information server, which may supply it to the requesting Web browser.

Also, an information server may contain, communicate, generate, obtain, and/or provide program component, system, user, and/or data communications, requests, and/or responses.

### User Interface

Computer interfaces in some respects are similar to automobile operation interfaces. Automobile operation interface elements such as steering wheels, gearshifts, and speedometers facilitate the access, operation, and display of automobile resources, and status. Computer interaction interface elements such as check boxes, cursors, menus, scrollers, and windows (collectively and commonly referred to as widgets) similarly facilitate the access, capabilities, operation, and display of data and computer hardware and operating system resources, and status. Operation interfaces are commonly called user interfaces. Graphical user interfaces (GUIs) such as the Apple's iOS, Macintosh Operating System's Aqua; IBM's OS/2; Google's Chrome; Microsoft's Windows varied UIs 2000/2003/3.1/95/98/CE/Millenium/Mobile/NT/Vista/XP (Server) (i.e., Aero, Surface, etc.); Unix's X-Windows (e.g., which may include additional Unix graphic interface libraries and layers such as K Desktop Environment (KDE), mythTV and GNU Network Object Model Environment (GNOME)), web interface libraries (e.g., ActiveX, AJAX, (D)HTML, FLASH, Java, JavaScript, etc. interface libraries such as, but not limited to, Dojo, jQuery(UI), MooTools, Prototype, script.aculo.us, SWFObject, Yahoo! User Interface, any of which may be used and) provide a baseline and means of accessing and displaying information graphically to users.

A user interface component 717 is a stored program component that is executed by a CPU. The user interface may be a conventional graphic user interface as provided by, with, and/or atop operating systems and/or operating environments such as already discussed. The user interface may allow for the display, execution, interaction, manipulation, and/or operation of program components and/or system facilities through textual and/or graphical facilities. The user interface provides a facility through which users may affect, interact, and/or operate a computer system. A user interface may communicate to and/or with other components in a component collection, including itself, and/or facilities of the like. Most frequently, the user interface communicates with operating systems, other program components, and/or the like. The user interface may contain, communicate, generate, obtain, and/or provide program component, system, user, and/or data communications, requests, and/or responses.

### Web Browser

A Web browser component 718 is a stored program component that is executed by a CPU. The Web browser may be a conventional hypertext viewing application such as Apple's (mobile) Safari, Google's Chrome, Microsoft Internet Explorer, Mozilla's Firefox, Netscape Navigator, and/or the like. Secure Web browsing may be supplied with 128 bit (or greater) encryption by way of HTTPS, SSL, and/or the like. Web browsers allowing for the execution of program components through facilities such as ActiveX, AJAX, (D)HTML, FLASH, Java, JavaScript, web browser plug-in APIs (e.g., FireFox, Safari Plug-in, and/or the like APIs), and/or the like. Web browsers and like information access tools may be integrated into PDAs, cellular telephones, and/or other mobile devices. A Web browser may communicate to and/or with other components in a component collection, including itself, and/or facilities of the like. Most frequently, the Web browser communicates with information servers, operating systems, integrated program components (e.g., plug-ins), and/or the like; e.g., it may contain, communicate, generate, obtain, and/or provide program component, system, user, and/or data communications, requests, and/or responses. Also, in place of a Web browser and information server, a combined application may be developed to perform similar operations of both. The combined application would similarly affect the obtaining and the provision of information to users, user agents, and/or the like from the LPC enabled nodes. The combined application may be nugatory on systems employing standard Web browsers.

### Mail Server

A mail server component 721 is a stored program component that is executed by a CPU 703. The mail server may be a conventional Internet mail server such as, but not limited to: dovecot, Courier IMAP, Cyrus IMAP, Maildir, Microsoft Exchange, sendmail, and/or the like. The mail server may allow for the execution of program components through facilities such as ASP, ActiveX, (ANSI) (Objective-) C (++), C# and/or .NET, CGI scripts, Java, JavaScript, PERL, PHP, pipes, Python, WebObjects, and/or the like. The mail server may support communications protocols such as, but not limited to: Internet message access protocol (IMAP), Messaging Application Programming Interface (MAPI)/Microsoft Exchange, post office protocol (POP3), simple mail transfer protocol (SMTP), and/or the like. The mail server can route, forward, and process incoming and outgoing mail messages that have been sent, relayed and/or otherwise traversing through and/or to the LPC.

Access to the LPC mail may be achieved through a number of APIs offered by the individual Web server components and/or the operating system.

Also, a mail server may contain, communicate, generate, obtain, and/or provide program component, system, user, and/or data communications, requests, information, and/or responses.

### Mail Client

A mail client component 722 is a stored program component that is executed by a CPU 703. The mail client may be a conventional mail viewing application such as Apple Mail, Microsoft Entourage, Microsoft Outlook, Microsoft Outlook Express, Mozilla, Thunderbird, and/or the like. Mail clients may support a number of transfer protocols, such as: IMAP, Microsoft Exchange, POP3, SMTP, and/or the like. A mail client may communicate to and/or with other components in a component collection, including itself, and/or facilities of the like. Most frequently, the mail client communicates with mail servers, operating systems, other mail clients, and/or the like; e.g., it may contain, communicate, generate, obtain, and/or provide program component, system, user, and/or data communications, requests, information, and/or responses. Generally, the mail client provides a facility to compose and transmit electronic mail messages.

### Cryptographic Server

A cryptographic server component 720 is a stored program component that is executed by a CPU 703, cryptographic processor 726, cryptographic processor interface 727, cryptographic processor device 728, and/or the like. Cryptographic processor interfaces will allow for expedition of encryption and/or decryption requests by the cryptographic component; however, the cryptographic component, alternatively, may run on a conventional CPU. The cryptographic component allows for the encryption and/or decryption of provided data. The cryptographic component allows for both symmetric and asymmetric (e.g., Pretty Good Protection (PGP)) encryption and/or decryption. The cryptographic component may employ cryptographic techniques such as, but not limited to: digital certificates (e.g., X.509 authentication framework), digital signatures, dual signatures, enveloping, password access protection, public key management, and/or the like. The cryptographic component will facilitate numerous (encryption and/or decryption) security protocols such as, but not limited to: checksum, Data Encryption Standard (DES), Elliptical Curve Encryption (ECC), International Data Encryption Algorithm (IDEA), Message Digest 5 (MD5, which is a one way hash operation), passwords, Rivest Cipher (RC5), Rijndael, RSA (which is an Internet encryption and authentication system that uses an algorithm developed in 1977 by Ron Rivest, Adi Shamir, and Leonard Adleman), Secure Hash Algorithm (SHA), Secure Socket Layer (SSL), Secure Hypertext Transfer Protocol (HTTPS), and/or the like. Employing such encryption security protocols, the LPC may encrypt all incoming and/or outgoing communications and may serve as node within a virtual private network (VPN) with a wider communications network. The cryptographic component facilitates the process of “security authorization” whereby access to a resource is inhibited by a security protocol wherein the cryptographic component effects authorized access to the secured resource. In addition, the cryptographic component may provide unique identifiers of content, e.g., employing and MD5 hash to obtain a unique signature for an digital audio file. A cryptographic component may communicate to and/or with other components in a component collection, including itself, and/or facilities of the like. The cryptographic component supports encryption schemes allowing for the secure transmission of information across a communications network to enable the LPC component to engage in secure transactions if so desired. The cryptographic component facilitates the secure accessing of resources on the LPC and facilitates the access of secured resources on remote systems; i.e., it may act as a client and/or server of secured resources. Most frequently, the cryptographic component communicates with information servers, operating systems, other program components, and/or the like. The cryptographic component may contain, communicate, generate, obtain, and/or provide program component, system, user, and/or data communications, requests, and/or responses.

### The LPC Database

The LPC database component 719 may be embodied in a database and its stored data. The database is a stored program component, which is executed by the CPU; the stored program component portion configuring the CPU to process the stored data. The database may be a conventional, fault tolerant, relational, scalable, secure database such as Oracle or Sybase. Relational databases are an extension of a flat file. Relational databases consist of a series of related tables. The tables are interconnected via a key field. Use of the key field allows the combination of the tables by indexing against the key field; i.e., the key fields act as dimensional pivot points for combining information from various tables. Relationships generally identify links maintained between tables by matching primary keys. Primary keys represent fields that uniquely identify the rows of a table in a relational database. More precisely, they uniquely identify rows of a table on the “one” side of a one-to-many relationship.

Alternatively, the LPC database may be implemented using various standard data-structures, such as an array, hash, (linked) list, struct, structured text file (e.g., XML), table, and/or the like. Such data-structures may be stored in memory and/or in (structured) files. In another alternative, an object-oriented database may be used, such as Frontier, ObjectStore, Poet, Zope, and/or the like. Object databases can include a number of object collections that are grouped and/or linked together by common attributes; they may be related to other object collections by some common attributes. Object-oriented databases perform similarly to relational databases with the exception that objects are not just pieces of data but may have other types of capabilities encapsulated within a given object. If the LPC database is implemented as a data-structure, the use of the LPC database 719 may be integrated into another component such as the LPC component 735. Also, the database may be implemented as a mix of data structures, objects, and relational structures. Databases may be consolidated and/or distributed in countless variations through standard data processing techniques. Portions of databases, e.g., tables, may be exported and/or imported and thus decentralized and/or integrated.

In one embodiment, the database component 719 includes several tables 719a-z:

An accounts table 719a includes fields such as, but not limited to: an accountID, accountOwnerID, accountContactID, assetIDs, deviceIDs, paymentIDs, transactionIDs, userIDs, accountType (e.g., agent, entity (e.g., corporate, non-profit, partnership, etc.), individual, etc.), accountCreationDate, accountUpdateDate, accountName, accountAddress, accountState, accountZIPcode, accountCountry, accountEmail, accountPhone, accountAuthKey, accountIPaddress, accountURLAccessCode, accountPortNo, accountAuthorizationCode, accountAccessPrivileges, accountPreferences, accountRestrictions, and/or the like;

A users table 719b includes fields such as, but not limited to: a userID, userSSN, taxID, userContactID, accountID, assetIDs, deviceIDs, paymentIDs, transactionIDs, userType (e.g., agent, entity (e.g., corporate, non-profit, partnership, etc.), individual, etc.), namePrefix, firstName, middleName, lastName, nameSuffix, DateOfBirth, userAge, userName, userEmail, userSocialAccountID, contactType, contactRelationship, userPhone, userAddress, userCity, userState, userZIPCode, userCountry, userAuthorizationCode, userAccessPrivilges, userPreferences, userRestrictions, and/or the like (the user table may support and/or track multiple entity accounts on a LPC);

An devices table 719c includes fields such as, but not limited to: deviceID, accountID, assetIDs, paymentIDs, deviceType, deviceName, deviceModel, deviceVersion, deviceSerialNo, devicelPaddress, deviceMACaddress, device_ECID, deviceUUID, deviceLocation, deviceCertificate, deviceOS, appIDs, deviceResources, deviceSession, authKey, deviceSecureKey, walletAppinstalledFlag, deviceAccessPrivileges, device Preferences, deviceRestrictions, and/or the like;

An apps table 719d includes fields such as, but not limited to: appID, appName, appType, appDependencies, accountID, deviceIDs, transactionID, userID, appStoreAuthKey, appStoreAccountID, appStorelPaddress, appStoreURLaccessCode, appStorePortNo, appAccessPrivileges, appPreferences, appRestrictions and/or the like;

An assets table 719e includes fields such as, but not limited to: assetID, distributorAccountID, distributorPaymentID, distributorOnwerID, assetType, assetName, assetCode, assetQuantity, assetCost, assetPrice, assetManufactuer, assetModelNo, assetSerialNo, assetLocation, assetAddress, assetState, assetZIPcode, assetState, assetCountry, assetEmail, assetlPaddress, assetURLaccessCode, assetOwnerAccountID, subscriptionIDs, assetAuthroizationCode, assetAccessPrivileges, assetPreferences, assetRestrictions, and/or the like;

A payments table 719f includes fields such as, but not limited to: paymentID, accountID, userID, paymentType, paymentAccountNo, paymentAccountName, paymentAccountAuthorizationCodes, paymentExpirationDate, paymentCCV, paymentRoutingNo, paymentRoutingType, paymentAddress, paymentState, paymentZIPcode, paymentCountry, paymentEmail, paymentAuthKey, paymentlPaddress, paymentURLaccessCode, paymentPortNo, paymentAccessPrivileges, paymentPreferences, payementRestrictions, and/or the like;

An transactions table 719g includes fields such as, but not limited to: transactionID, accountID, assetIDs, deviceIDs, paymentIDs, transactionIDs, userID, transactionType, transactionDate, transactionAmount, transactionQuantity, transactionDetails, transactionNo, transactionAccessPrivileges, transactionPreferences, transactionRestrictions, and/or the like;

A historical data table 719h may include fields such as, but not limited to: data_id, data_type, data_instrument_type, data_asset_class, data_time, data_date, data_year, data_equity_percentage, data_return, and/or the like.

A data provider table 719i may include fields such as, but not limited to: provide_id, provider_name, provider_type, provider_data_type, provider_index_type, provider_server_ip, provider_server_id, provider_url, and/or the like.

A risk boundary table 719j may include fields such as, but not limited to: boundary_id, boundary_type, boundary_customization, boundary_age_subtable, boundary_percentage_subtable, boundary_performance, and/or the like.

A portfolio table 719k may include fields such as, but not limited to portfolio_id, portfolio_name, portfolio_user_id, portfolio_sector, portfolio_risk_boundary, portfolio_start_date, portfolio_end_date, portfolio_equity_percentage, portfolio_bond_percentage, portfolio_other_percentage, and/or the like.

A performance table 719l may include fields such as, but not limited to: start_date, end_date, portfolio_id, return, sector_return, GDP, unemployment, inflation, what_if_return, index_return, and/or the like.

A market_data table 719z includes fields such as, but not limited to: market_data_feed_ID, asset_ID, asset_symbol, asset_name, spot_price, bid_price, ask_price, and/or the like; in one embodiment, the market data table is populated through a market data feed (e.g., Bloomberg's PhatPipe, Dun & Bradstreet, Reuter's Tib, Triarch, etc.), for example, through Microsoft's Active Template Library and Dealing Object Technology's real-time toolkit Rtt.Multi.

In one embodiment, the LPC database may interact with other database systems. For example, employing a distributed database system, queries and data access by search LPC component may treat the combination of the LPC database, an integrated data security layer database as a single database entity.

In one embodiment, user programs may contain various user interface primitives, which may serve to update the LPC. Also, various accounts may require custom database tables depending upon the environments and the types of clients the LPC may need to serve. It should be noted that any unique fields may be designated as a key field throughout. In an alternative embodiment, these tables have been decentralized into their own databases and their respective database controllers (i.e., individual database controllers for each of the above tables). Employing standard data processing techniques, one may further distribute the databases over several computer systemizations and/or storage devices. Similarly, configurations of the decentralized database controllers may be varied by consolidating and/or distributing the various database components 719a-z. The LPC may be configured to keep track of various settings, inputs, and parameters via database controllers.

The LPC database may communicate to and/or with other components in a component collection, including itself, and/or facilities of the like. Most frequently, the LPC database communicates with the LPC component, other program components, and/or the like. The database may contain, retain, and provide information regarding other nodes and data.

### The LPCs

The LPC component 735 is a stored program component that is executed by a CPU. In one embodiment, the LPC component incorporates any and/or all combinations of the aspects of the LPC that was discussed in the previous figures. As such, the LPC affects accessing, obtaining and the provision of information, services, transactions, and/or the like across various communications networks. The features and embodiments of the LPC discussed herein increase network efficiency by reducing data transfer requirements the use of more efficient data structures and mechanisms for their transfer and storage. As a consequence, more data may be transferred in less time, and latencies with regard to transactions, are also reduced. In many cases, such reduction in storage, transfer time, bandwidth requirements, latencies, etc., will reduce the capacity and structural infrastructure requirements to support the LPC's features and facilities, and in many cases reduce the costs, energy consumption/requirements, and extend the life of LPC's underlying infrastructure; this has the added benefit of making the LPC more reliable. Similarly, many of the features and mechanisms are designed to be easier for users to use and access, thereby broadening the audience that may enjoy/employ and exploit the feature sets of the LPC; such ease of use also helps to increase the reliability of the LPC. In addition, the feature sets include heightened security as noted via the Cryptographic components 720, 726, 728 and throughout, making access to the features and data more reliable and secure

The LPC transforms LPC Server data request (e.g., see 201 in FIG. 2, etc.) inputs, via LPC components (e.g., historical data collector 742 (e.g., see FIG. 4B, etc.), risk boundary generation 743 (e.g., see FIGS. 3B, 5D-5E and 6C-6E, etc.), user customization analytics 744 (e.g., see FIG. 4A, etc.), portfolio construction 745 (e.g., see FIG. 3A, etc.)), into sector-based portfolio investment transaction records outputs.

The LPC component enabling access of information between nodes may be developed by employing standard development tools and languages such as, but not limited to: Apache components, Assembly, ActiveX, binary executables, (ANSI) (Objective-) C (++), C# and/or .NET, database adapters, CGI scripts, Java, JavaScript, mapping tools, procedural and object oriented development tools, PERL, PHP, Python, shell scripts, SQL commands, web application server extensions, web development environments and libraries (e.g., Microsoft's ActiveX; Adobe AIR, FLEX & FLASH; AJAX; (D)HTML; Dojo, Java; JavaScript; jQuery(UI); MooTools; Prototype; script.aculo.us; Simple Object Access Protocol (SOAP); SWFObject; Yahoo! User Interface; and/or the like), WebObjects, and/or the like. In one embodiment, the LPC server employs a cryptographic server to encrypt and decrypt communications. The LPC component may communicate to and/or with other components in a component collection, including itself, and/or facilities of the like. Most frequently, the LPC component communicates with the LPC database, operating systems, other program components, and/or the like. The LPC may contain, communicate, generate, obtain, and/or provide program component, system, user, and/or data communications, requests, and/or responses.

### Distributed LPCs

The structure and/or operation of any of the LPC node controller components may be combined, consolidated, and/or distributed in any number of ways to facilitate development and/or deployment. Similarly, the component collection may be combined in any number of ways to facilitate deployment and/or development. To accomplish this, one may integrate the components into a common code base or in a facility that can dynamically load the components on demand in an integrated fashion.

The component collection may be consolidated and/or distributed in countless variations through standard data processing and/or development techniques. Multiple instances of any one of the program components in the program component collection may be instantiated on a single node, and/or across numerous nodes to improve performance through load-balancing and/or data-processing techniques. Furthermore, single instances may also be distributed across multiple controllers and/or storage devices; e.g., databases. All program component instances and controllers working in concert may do so through standard data processing communication techniques.

The configuration of the LPC controller will depend on the context of system deployment. Factors such as, but not limited to, the budget, capacity, location, and/or use of the underlying hardware resources may affect deployment requirements and configuration. Regardless of if the configuration results in more consolidated and/or integrated program components, results in a more distributed series of program components, and/or results in some combination between a consolidated and distributed configuration, data may be communicated, obtained, and/or provided. Instances of components consolidated into a common code base from the program component collection may communicate, obtain, and/or provide data. This may be accomplished through intra-application data processing communication techniques such as, but not limited to: data referencing (e.g., pointers), internal messaging, object instance variable communication, shared memory space, variable passing, and/or the like.

If component collection components are discrete, separate, and/or external to one another, then communicating, obtaining, and/or providing data with and/or to other component components may be accomplished through inter-application data processing communication techniques such as, but not limited to: Application Program Interfaces (API) information passage; (distributed) Component Object Model ((D)COM), (Distributed) Object Linking and Embedding ((D)OLE), and/or the like), Common Object Request Broker Architecture (CORBA), Jini local and remote application program interfaces, JavaScript Object Notation (JSON), Remote Method Invocation (RMI), SOAP, process pipes, shared files, and/or the like. Messages sent between discrete component components for inter-application communication or within memory spaces of a singular component for intra-application communication may be facilitated through the creation and parsing of a grammar. A grammar may be developed by using development tools such as lex, yacc, XML, and/or the like, which allow for grammar generation and parsing capabilities, which in turn may form the basis of communication messages within and between components.

For example, a grammar may be arranged to recognize the tokens of an HTTP post command, e.g.:
w3c—post http:// . . . Value1

where Value1 is discerned as being a parameter because “http://” is part of the grammar syntax, and what follows is considered part of the post value. Similarly, with such a grammar, a variable “Value1” may be inserted into an “http://” post command and then sent. The grammar syntax itself may be presented as structured data that is interpreted and/or otherwise used to generate the parsing mechanism (e.g., a syntax description text file as processed by lex, yacc, etc.). Also, once the parsing mechanism is generated and/or instantiated, it itself may process and/or parse structured data such as, but not limited to: character (e.g., tab) delineated text, HTML, structured text streams, XML, and/or the like structured data. In another embodiment, inter-application data processing protocols themselves may have integrated and/or readily available parsers (e.g., JSON, SOAP, and/or like parsers) that may be employed to parse (e.g., communications) data. Further, the parsing grammar may be used beyond message parsing, but may also be used to parse: databases, data collections, data stores, structured data, and/or the like. Again, the desired configuration will depend upon the context, environment, and requirements of system deployment.

For example, in some implementations, the LPC controller may be executing a PHP script implementing a Secure Sockets Layer (“SSL”) socket server via the information server, which listens to incoming communications on a server port to which a client may send data, e.g., data encoded in JSON format. Upon identifying an incoming communication, the PHP script may read the incoming message from the client device, parse the received JSON-encoded text data to extract information from the JSON-encoded text data into PHP script variables, and store the data (e.g., client identifying information, etc.) and/or extracted information in a relational database accessible using the Structured Query Language (“SQL”). An exemplary listing, written substantially in the form of PHP/SQL commands, to accept JSON-encoded input data from a client device via a SSL connection, parse the data to extract variables, and store the data to a database, is provided below:

```
<?PHP
header(‘Content-Type: text/plain’);
// set ip address and port to listen to for incoming data
$address = ‘192.168.0.100’;
$port = 255;
// create a server-side SSL socket, listen for/accept incoming
communication
$sock = socket_create(AF_INET, SOCK_STREAM, 0);
socket_bind($sock, $address, $port) or die(‘Could not bind to address’);
socket_listen($sock);
$client = socket_accept($sock);
// read input data from client device in 1024 byte blocks until end of
message do {
    $input = “ ”;
    $input = socket_read($client, 1024);
    $data .= $input;
} while($input != “ ”);
// parse data to extract variables
$obj = json_decode($data, true);
// store input data in a database
mysql_connect(″201.408.185.132″,$DBserver,$password); // access
database server
mysql_select(″CLIENT_DB.SQL″); // select database to append
mysql_query(“INSERT INTO UserTable (transmission)
VALUES ($data)”); // add data to UserTable table in a CLIENT database
mysql_close(″CLIENT_DB.SQL″); // close connection to database
?>
```

Also, the following resources may be used to provide example embodiments regarding SOAP parser implementation:

http://www.xav.com/perl/site/lib/SOAP/Parser.html
http://publib.boulder.ibm.com/infocenter/tivihelp/v2r1/
index.jsp?topic=/com.ibm.IBMDI.doc/referenceguide295.htm

and other parser implementations:

http://publib.boulder.ibm.com/infocenter/tivihelp/v2r1/
index.jsp?topic=/com.ibm.IBMDI.doc/referenceguide259.htm

all of which are hereby expressly incorporated by reference.

In order to address various issues and advance the art, the entirety of this application for Life Cycle Based Portfolio Construction Platform Apparatuses, Methods and Systems (including the Cover Page, Title, Headings, Field, Background, Summary, Brief Description of the Drawings, Detailed Description, Claims, Abstract, Figures, Appendices, and otherwise) shows, by way of illustration, various embodiments in which the claimed innovations may be practiced. The advantages and features of the application are of a representative sample of embodiments only, and are not exhaustive and/or exclusive. They are presented only to assist in understanding and teach the claimed principles. It should be understood that they are not representative of all claimed innovations. As such, certain aspects of the disclosure have not been discussed herein. That alternate embodiments may not have been presented for a specific portion of the innovations or that further undescribed alternate embodiments may be available for a portion is not to be considered a disclaimer of those alternate embodiments. It will be appreciated that many of those undescribed embodiments incorporate the same principles of the innovations and others are equivalent. Thus, it is to be understood that other embodiments may be utilized and functional, logical, operational, organizational, structural and/or topological modifications may be made without departing from the scope and/or spirit of the disclosure. As such, all examples and/or embodiments are deemed to be non-limiting throughout this disclosure. Also, no inference should be drawn regarding those embodiments discussed herein relative to those not discussed herein other than it is as such for purposes of reducing space and repetition. For instance, it is to be understood that the logical and/or topological structure of any combination of any program components (a component collection), other components, data flow order, logic flow order, and/or any present feature sets as described in the figures and/or throughout are not limited to a fixed operating order and/or arrangement, but rather, any disclosed order is exemplary and all equivalents, regardless of order, are contemplated by the disclosure. Similarly, descriptions of embodiments disclosed throughout this disclosure, any reference to direction or orientation is merely intended for convenience of description and is not intended in any way to limit the scope of described embodiments. Relative terms such as “lower,” “upper,” “horizontal,” “vertical,” “above,” “below,” “up,” 7 “down,” “top” and “bottom” as well as derivative thereof (e.g., “horizontally,” 8 “downwardly,” “upwardly,” etc.) should not be construed to limit embodiments, and instead, again, are offered for convenience of description of orientation. These relative descriptors are for convenience of description only and do not require that any embodiments be constructed or operated in a particular orientation unless explicitly indicated as such. Terms such as “attached,” “affixed,” “connected,” “coupled,” “interconnected,” and similar may refer to a relationship wherein structures are secured or attached to one another either directly or indirectly through intervening structures, as well as both movable or rigid attachments or relationships, unless expressly described otherwise. Furthermore, it is to be understood that such features are not limited to serial execution, but rather, any number of threads, processes, services, servers, and/or the like that may execute asynchronously, concurrently, in parallel, simultaneously, synchronously, and/or the like are contemplated by the disclosure. As such, some of these features may be mutually contradictory, in that they cannot be simultaneously present in a single embodiment. Similarly, some features are applicable to one aspect of the innovations, and inapplicable to others. In addition, the disclosure includes other innovations not presently claimed. Applicant reserves all rights in those presently unclaimed innovations including the right to claim such innovations, file additional applications, continuations, continuations in part, divisions, and/or the like thereof. As such, it should be understood that advantages, embodiments, examples, functional, features, logical, operational, organizational, structural, topological, and/or other aspects of the disclosure are not to be considered limitations on the disclosure as defined by the claims or limitations on equivalents to the claims. It is to be understood that, depending on the particular needs and/or characteristics of a LPC individual and/or enterprise user, database configuration and/or relational model, data type, data transmission and/or network framework, syntax structure, and/or the like, various embodiments of the LPC, may be implemented that enable a great deal of flexibility and customization. For example, aspects of the LPC may be adapted for operation management and information systems. While various embodiments and discussions of the LPC have included portfolio information technologies construction, however, it is to be understood that the embodiments described herein may be readily configured and/or customized for a wide variety of other applications and/or implementations.

What is claimed is:

1. A cycle based portfolio management apparatus, comprising:
a computing processor; and
a memory disposed in communication with the computing processor, and storing computing processor-executable instructions, said processor-executable instructions executable by the computing processor to:
receive historical investment data indicating investment returns from a data provider;
generate a risk boundary curve for equity allocation at different investor age segments based on the received historical investment data;
receive a portfolio construction request;
retrieve an equity allocation boundary value from the generated risk boundary curve based on an investor age; and
generate a life cycle based portfolio based on the retrieved equity allocation boundary value.

2. The apparatus of claim 1, wherein the risk boundary curve comprises a piecewise linear line.

3. The apparatus of claim 1, wherein risk boundary curve is generated via backward induction from a senior age segment to a junior age segment.

4. The apparatus of claim 1, wherein the risk boundary curve is determined based on an optimal average discounted utility calculation over a set of adverse scenarios calculated based on different equity allocation percentages.

5. The apparatus of claim 1, wherein the risk boundary comprises a risk capacity glidepath constraint.

6. A cycle-based portfolio management apparatus, comprising:
a memory;
a component collection in the memory, comprising:
a historical investment data component;
a risk boundary curve component;
an equity allocation boundary value component; and
a life cycle boundary component;
a processor disposed in communication with the memory, and configured to issue a plurality of processing instructions from the component collection stored in the memory,
wherein the processor issues instructions from component collection, stored in the memory, to:
receive historical investment data indicating investment returns from a network data provider;
generate a risk boundary curve for equity allocation at different investor age segments based on the received historical investment data, and store risk boundary curve data in said risk boundary curve component;
receive a portfolio construction request;
retrieve an equity allocation boundary value from the generated risk boundary curve based on a user's age, and store said equity allocation value in said equity allocation value component; and
generate a life cycle based portfolio based on the retrieved equity allocation boundary value, and store life cycle based portfolio data in said life cycle boundary component.

7. The apparatus of claim 6, wherein the risk boundary curve component comprises a piecewise linear line component.

8. The apparatus of claim 6, wherein the risk boundary curve component contains backward induction data from a senior age segment to a junior age segment.

9. The apparatus of claim 6, wherein the risk boundary curve component contains data determined from an optimal average discounted utility calculation over a set of adverse scenarios calculated based on different equity allocation percentages.

10. The apparatus of claim 6, wherein the risk boundary curve component comprises a risk capacity glidepath constraint component

11. A processor-readable non-transient medium storing processor-issuable instructions, for access by a processor-executable program component to provide an interface for cycle-based portfolio management, comprising instructions for:
receiving historical investment data indicating investment returns from a data provider;
generating a risk boundary curve for equity allocation at different investor age segments based on the received historical investment data;
receiving a portfolio construction request;
retrieving an equity allocation boundary value from the generated risk boundary curve based on an investor age; and
generating a life cycle based portfolio based on the retrieved equity allocation boundary value.

12. The processor-readable non-transient medium of claim 11, further comprising instructions for using a piecewise linear line to establish a risk boundary curve.

13. The processor-readable non-transient medium of claim 11, further comprising instructions for generating a risk boundary curve via backward induction from a senior age segment to a junior age segment.

14. The processor-readable non-transient medium of claim 11, further comprising instructions for determining a risk boundary curve based on an optimal average discounted utility calculation over a set of adverse scenarios calculated based on different equity allocation percentages.

15. A of providing an interface for cycle-based portfolio management, comprising:
receiving historical investment data indicating investment returns from a data provider;
generating a risk boundary curve for equity allocation at different investor age segments based on the received historical investment data;
receiving a portfolio construction request;
retrieving an equity allocation boundary value from the generated risk boundary curve based on an investor age; and
generating a life cycle based portfolio based on the retrieved equity allocation boundary value.

16. The method of claim 15, further comprising using a piecewise linear line to establish a risk boundary curve.

17. The method of claim 15, further comprising generating a risk boundary curve via backward induction from a senior age segment to a junior age segment.

18. The method of claim 15, further determining a risk boundary curve based on an optimal average discounted utility calculation over a set of adverse scenarios calculated based on different equity allocation percentages.

19. A life cycle based portfolio management system, comprising:
a computing processor; and
a memory disposed in communication with the computing processor, and storing computing processor-executable instructions, said processor-executable instructions executable by the computing processor to:
receive and analyze historical investment data indicating investment returns from a data provider, to generate risk boundary parameter metrics for equity allocation at different investor age segments based on the received historical investment data;
receive a portfolio construction request and demographic information from a user;
retrieve equity allocation boundary value metrics from the generated risk boundary parameter metrics based on said demographic information regarding said user;
generate a proposed life cycle based portfolio based on the retrieved equity allocation boundary value; and
graphically display said proposed life cycle based portfolio to said user.
